(19) United States
(12) Patent Application Publication
(10) Pub. No.: US 2024/0284956 A1
(43) Pub. Date: Aug. 29, 2024

(54) SOLAR THERMAL PROCESSING OF AGRICULTURAL PRODUCTS

(71) Applicant: Karl von Kries, Roseville, CA (US)

(72) Inventor: Karl von Kries, Pismo Beach, CA (US)

(21) Appl. No.: 18/114,147

(22) Filed: Feb. 24, 2023

(51) Int. Cl. A23N 12/10; A23L 5/10; A23N 12/12; F24S 20/30; F24S 50/80

(52) U.S. Cl. CPC A23N 12/10; A23L 5/15; A23N 12/125; F24S 20/30; F24S 50/80

(57) ABSTRACT

An agricultural product processing (roasting) system that uses solar power as the primary heat source. An embodiment includes two rotating hollow chambers for containing agricultural products, such as beans or nuts, during a roasting session. An array of heliostats concentrates reflected solar radiation onto the surface of each hollow chamber, typically one chamber at a time, while the other chamber is cooling or being serviced. The rotational velocity is controlled to ensure even heating from the solar heliostat array, and temperature and humidity sensors may be used to monitor and control the system. Various actuators control the rotational velocity, the opening or closing of vents or perhaps louvers, the directional pointing of the heliostat array, and the opening of a door to empty the hollow chamber after processing.

### CROSS-REFERENCE TO RELATED APPLICATIONS

None.

### TECHNICAL FIELD

The technology disclosed herein relates generally to agricultural products processing equipment and is particularly directed to agricultural roasters of the type which use solar power as the primary heat source. Embodiments are specifically disclosed as a roasting system with two rotating hollow chambers for containing agricultural products, such as beans or nuts.

An array of heliostats concentrates solar radiation onto the surface of each hollow chamber, typically one chamber at a time, while the other chamber is cooling or being serviced. The rotational velocity is controlled to ensure even heating from the solar heliostat array, and temperature and humidity sensors are typically used to monitor and control the system, including when to begin and end the procedure. Other sensors may also be provided, if desired, such as at least one photoelectric sensor, acting as a solar intensity sensor.

Various actuators are included to control the rotational velocity, the opening or closing of vents and/or perhaps adjustable louvers, directional pointing of the heliostat array, and other criteria based upon the various sensor inputs, including ‘cooking time’ and time of day, and also based upon the type of agricultural product being processed. The hollow chambers are typically mounted in an enclosure that includes most of the sensors and actuators, and also may include at least one solar panel to convert some of the solar radiation into electricity to provide a power source for the system controller, and for the actuators and sensors. Alternatively, an outside (separate) electrical power source could be used for those purposes, if such a separate electrical power source is readily available.

The rotating hollow chamber, or ‘drum’, can be mounted so as to rotate during the ‘cooking’ cycle. In a first embodiment, the hollow chamber is rotatable about a spin axis, which typically is along a horizontal line. This version of the hollow chamber has a handle and door that opens along the cylindrical (curved) outer surface of the drum, for ease of loading and unloading the agricultural products being processed. After the heating procedure has been completed, the agricultural products can be unloaded onto a cooling area, which can simply be a floor area, or a stationary cooling tray, or perhaps a moving conveyor.

In a second embodiment, the hollow chamber is rotatable about two other axes, in which a framework that the hollow chamber is mounted to has two pivot axes, such that the framework and hollow chamber can both tilt together about a horizontal line, and also the hollow chamber can simultaneously rotate about a ‘vertical’ axis, using mounting pedestals at the top and bottom of the hollow chamber. The so-called ‘vertical’ axis is only vertical when the framework and hollow chamber are not being tilted; in other words, the ‘vertical’ axis itself becomes tilted when the framework/chamber subassembly is also tilted. However, the two axes are always perpendicular to one another. This version of the hollow chamber also has a handle and door; however, this handle is mounted on a flat, side surface (i.e., acting as the door) which can be tilted either up or down, for ease of loading and unloading the agricultural products being processed. The associated drawings effectively show these features.

In another embodiment, using the rotational hardware of either the first or second embodiments discussed above, the system controller has the ability for automatically controlling both the heliostats and the louvers in combination, so only one type needs to be adjusted for controlling the product profile in a particular heating session of the agricultural products being processed.

In a further embodiment, using the rotational hardware of either the first or second embodiments discussed above, the system controller has the ability for automatically controlling the product profile in a particular heating session of the agricultural products being processed, based primarily on the elapsed time of the heating cycle, while using a single photosensor as a solar intensity sensor, for automatically controlling the heliostats.

In yet another embodiment, using the rotational hardware of either the first or second embodiments discussed above, the system controller has the ability for automatically controlling the product profile in a particular heating session of the agricultural products being processed based solely on the elapsed time of the heating cycle, while a person oversees the control of the heliostats, for manually controlling the heliostats.

### STATEMENT REGARDING FEDERALLY SPONSORED RESEARCH OR DEVELOPMENT

None.

### BACKGROUND

A number of widely-used agricultural and similar processes use heat for roasting or curing the ultimate products, such as for coffee roasting, fish drying, nut roasting, hops drying, grain drying, fruit drying, etc.

Heliostats can provide a low-cost source of heat for many of these processes, with zero carbon gas emissions, by using solar energy as the primary heat source. The physical location on the Earth's surface will often be an important consideration as to ‘where’ a solar-powered agricultural processing system would be most useful.

### SUMMARY

Accordingly, it is an advantage to provide a solar thermal processing system that uses solar energy to process agricultural products, using an array of heliostats to aim reflected solar radiant energy toward a hollow chamber that contains an agricultural product that is to be ‘cured’ or otherwise processed by application of thermal energy.

It is another advantage to provide a solar thermal processing system that uses solar energy to process agricultural products, using an array of heliostats to aim reflected solar radiant energy toward a hollow chamber containing an agricultural product, in which at least two hollow chambers are provided in relatively close proximity to one another, so that the radiant energy from the heliostats can be aimed at a first chamber for thermal processing of the internal agricultural products, while a second chamber may be cooling its agricultural products from a previous heating session, by the heliostats.

It is yet another advantage to provide a solar thermal processing system that uses solar energy to process agricultural products, using an array of heliostats to aim reflected solar radiant energy toward a hollow chamber containing an agricultural product, in which a hollow chamber is rotatable during a thermal processing session, and the rate of rotation is monitored and controlled to provide a predetermined ‘Roasting Profile’ that is appropriate for the given agricultural products within the hollow chamber. This ‘Roasting Profile’ may also be referred to herein as a ‘Product Profile.’ It will be understood that each type of agricultural product (e.g., coffee beans) will likely have a preferred ‘Product Profile’ that is different from a preferred ‘Product Profile’ for other types of agricultural products (e.g., peanuts).

It is still another advantage to provide a solar thermal processing system that uses solar energy to process agricultural products, using an array of heliostats to aim reflected solar radiant energy toward a hollow chamber containing an agricultural product, in which a hollow chamber is rotatable during a thermal processing session, and in which the internal temperature and humidity are monitored and controlled to provide a predetermined ‘Product Profile’ that is appropriate for the given agricultural products within the hollow chamber.

It is a further advantage to provide a solar thermal processing system that uses solar energy to process agricultural products, using an array of heliostats to aim reflected solar radiant energy toward a hollow chamber containing an agricultural product, in which a hollow chamber is rotatable during a thermal processing session, and in which the heating time of the hollow chamber is a primary controlling parameter for providing a predetermined ‘Product Profile’ that is appropriate for the given agricultural products within the hollow chamber.

It is a yet further advantage to provide a solar thermal processing system that uses solar energy to process agricultural products, using an array of heliostats to aim reflected solar radiant energy toward a hollow chamber containing an agricultural product, in which a hollow chamber is rotatable during a thermal processing session, and in which the internal temperature and humidity are monitored and controlled to provide a predetermined ‘Product Profile’ that is appropriate for the given agricultural products within the hollow chamber, using a methodology that involves the use of varying the number of heliostats that are aimed at the hollow chamber to vary the temperature, and/or using a set (subassembly) of adjustable louvers to control and vary the percentage of reflected solar radiant energy that is allowed to strike the hollow chamber, and/or using one or more vents to release hot and/or humid air from the interior of the hollow chamber during the processing operation, and the use of other control procedures.

It is still a further advantage to provide a solar thermal processing system that uses solar energy to process agricultural products, using an array of heliostats to aim reflected solar radiant energy toward a hollow chamber containing an agricultural product during a thermal processing session, in which a hollow chamber is rotatable about a single axis in a first embodiment, the hollow chamber is rotatable about a two separate axes and in a second embodiment, to assist in having a uniform temperature and humidity gradient throughout the entire agricultural products within the hollow chamber.

Additional advantages and other novel features will be set forth in part in the description that follows and in part will become apparent to those skilled in the art upon examination of the following or may be learned with the practice of the technology disclosed herein.

To achieve the foregoing and other advantages, and in accordance with one aspect, a solar thermal processing system is provided, which comprises: (a) at least one heliostat, and at least one aiming actuator that controls the at least one heliostat; (b) at least one rotatable hollow chamber, having a door that opens for loading and unloading an agricultural product to and from an interior space of the at least one rotatable hollow chamber; (c) at least one sensor for detecting a predetermined physical parameter that is related to at least one of: (i) the at least one heliostat and (ii) the at least one rotatable hollow chamber; (d) at least one motor that, if actuated, rotates the at least one rotatable hollow chamber; (e) a cooling area for temporarily holding the agricultural product for cooling, after the agricultural product has been removed from the interior space of the at least one rotatable hollow chamber; (f) a system controller that includes: (i) at least one processing circuit; (ii) at least one memory circuit including instructions executable by the processing circuit; and (iii) at least one input/output interface circuit that is in communication with the at least one sensor and with the at least one processing circuit; and (g) an electrical power source; wherein: (h) the at least one processing circuit is operable to control a thermal processing cycle so as to: (i) control the at least one aiming actuator to cause the at least one heliostat to aim reflected solar radiant energy at the at least one rotatable hollow chamber that contains the agricultural product; (ii) control the at least one motor to rotate the at least one rotatable hollow chamber; (iii) monitor the predetermined physical parameter, using the at least one sensor; (iv) follow a predetermined product profile to adjust the at least one aiming actuator, to control the amount of reflected solar radiant energy that strikes the surface of the at least one rotatable hollow chamber containing the agricultural product; (v) complete the predetermined product profile, and then: (vi) empty the agricultural product from the interior space of the at least one rotatable hollow chamber, and place the agricultural product on the cooling area.

In accordance with another aspect, a solar thermal processing system is provided, which comprises: (a) at least one heliostat, and at least one aiming actuator that controls the at least one heliostat; (b) at least one rotatable hollow chamber, having a door that opens for loading and unloading an agricultural product to and from an interior space of the at least one rotatable hollow chamber; (c) at least one sensor for detecting a predetermined physical parameter that is related to at least one of: (i) the at least one heliostat and (ii) the at least one rotatable hollow chamber; (d) at least one motor that, if actuated, rotates the at least one rotatable hollow chamber; (e) at least one louver actuator that, if actuated, adjusts at least one louver subassembly that controls an amount of visible electromagnetic energy that is permitted to strike a surface of the at least one rotatable hollow chamber; (f) a cooling area for temporarily holding the agricultural product for cooling, after the agricultural product has been removed from the interior space of the at least one rotatable hollow chamber; (g) a system controller that includes: (i) at least one processing circuit; (ii) at least one memory circuit including instructions executable by the processing circuit; and (iii) at least one input/output interface circuit that is in communication with the at least one sensor and with the at least one processing circuit; and (h) an electrical power source; wherein: (i) the at least one processing circuit is operable to control a thermal processing cycle so as to: (i) control the at least one aiming actuator to cause the at least one heliostat to aim reflected solar radiant energy at the at least one rotatable hollow chamber that contains the agricultural product; (ii) control the at least one motor to rotate the at least one rotatable hollow chamber; (iii) monitor the predetermined physical parameter, using the at least one sensor; (iv) follow a predetermined product profile to adjust at least one of: (A) the at least one aiming actuator, and (B) the at least one louver actuator; wherein: (C) a first one of the at least one aiming actuator and the at least one louver actuator may be allowed to remain at its present setting, while a second one of the at least one aiming actuator and the at least one louver actuator is controlled in real time so as to alter its setting to control the amount of reflected solar radiant energy that strikes the surface of the at least one rotatable hollow chamber containing the agricultural product; or (D) both the first one and the second one of the at least one aiming actuator and the at least one louver actuator may be controlled simultaneously in real time so as to alter both of their settings to control the amount of reflected solar radiant energy that strikes the surface of the at least one rotatable hollow chamber containing the agricultural product; (v) complete the predetermined product profile, and then: (vi) empty the agricultural product from the interior space of the at least one rotatable hollow chamber, and place the agricultural product on the cooling area.

In accordance with yet another aspect, a solar thermal processing system is provided, which comprises: (a) at least one heliostat, and at least one aiming actuator that controls the at least one heliostat; (b) at least one rotatable hollow chamber, having a door that opens for loading and unloading an agricultural product to and from an interior space of the at least one rotatable hollow chamber; (c) at least one motor that, if actuated, rotates the at least one rotatable hollow chamber; (d) a cooling area for temporarily holding the agricultural product for cooling, after the agricultural product has been removed from the interior space of the at least one rotatable hollow chamber; (e) a system controller that includes: (i) at least one processing circuit; (ii) at least one memory circuit including instructions executable by the processing circuit; and (iii) at least one input/output interface circuit that is in communication with the at least one processing circuit; and (f) an electrical power source; wherein: (g) the at least one processing circuit is operable to control a thermal processing cycle so as to: (i) control the at least one motor to rotate the at least one rotatable hollow chamber; (ii) follow a predetermined product profile to monitor elapsed time for the thermal processing cycle; (iii) control, either manually or automatically, the at least one aiming actuator to cause the at least one heliostat to aim reflected solar radiant energy at the at least one rotatable hollow chamber that contains the agricultural product; (iv) complete the predetermined product profile, as determined once the elapsed time reaches a predetermined time value, and then: (v) empty the agricultural product from the interior space of the at least one rotatable hollow chamber, and place the agricultural product on the cooling area.

In accordance with a further aspect, a method for controlling a solar thermal processing system is provided, in which the method comprises: (a) providing: (i) at least one heliostat, and at least one aiming actuator that controls the at least one heliostat; (ii) at least one rotatable hollow chamber, having a door that opens for loading and unloading an agricultural product to and from an interior space of the at least one rotatable hollow chamber; (iii) at least one sensor for detecting a predetermined physical parameter that is related to at least one of: (i) the at least one heliostat and (ii) the at least one rotatable hollow chamber; (iv) at least one motor that, if actuated, rotates the at least one rotatable hollow chamber; (v) a cooling area for temporarily holding the agricultural product for cooling, after the agricultural product has been removed from the interior space of the at least one rotatable hollow chamber; (vi) a system controller that includes: (A) at least one processing circuit; (B) at least one memory circuit including instructions executable by the processing circuit; and (C) at least one input/output interface circuit that is in communication with the at least one sensor and with the at least one processing circuit; and (vii) an electrical power source; and (b) controlling a thermal processing cycle, by: (i) controlling the at least one aiming actuator to cause the at least one heliostat to aim reflected solar radiant energy at the at least one rotatable hollow chamber that contains the agricultural product; (ii) controlling the at least one motor to rotate the at least one rotatable hollow chamber; (iii) monitoring the predetermined physical parameter, using the at least one sensor; (iv) following a predetermined product profile by adjusting the at least one aiming actuator, thereby controlling the amount of reflected solar radiant energy that strikes the surface of the at least one rotatable hollow chamber containing the agricultural product; (v) completing the predetermined product profile, and then: (vi) emptying the agricultural product from the interior space of the at least one rotatable hollow chamber, and place the agricultural product on the cooling area.

In accordance with a still further aspect, a method for controlling a solar thermal processing system is provided, in which the method comprises: (a) providing: (i) at least one heliostat, and at least one aiming actuator that controls the at least one heliostat; (ii) at least one rotatable hollow chamber, having a door that opens for loading and unloading an agricultural product to and from an interior space of the at least one rotatable hollow chamber; (iii) at least one motor that, if actuated, rotates the at least one rotatable hollow chamber; (iv) a cooling area for temporarily holding the agricultural product for cooling, after the agricultural product has been removed from the interior space of the at least one rotatable hollow chamber; (v) a system controller that includes: (A) at least one processing circuit; (B) at least one memory circuit including instructions executable by the processing circuit; and (C) at least one input/output interface circuit that is in communication with the at least one processing circuit; and (vi) an electrical power source; and (b) controlling a thermal processing cycle, by: (i) controlling the at least one motor to rotate the at least one rotatable hollow chamber; (ii) following a predetermined product profile to monitor elapsed time for the thermal processing cycle; (iii) controlling, either manually or automatically, the at least one aiming actuator to cause the at least one heliostat to aim reflected solar radiant energy at the at least one rotatable hollow chamber that contains the agricultural product; (iv) completing the predetermined product profile, as determined once the elapsed time reaches a predetermined time value, and then: (v) emptying the agricultural product from the interior space of the at least one rotatable hollow chamber, and place the agricultural product on the cooling area.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is a perspective view of the major components of a solar thermal processing system for use in processing agricultural products, as constructed according to the principles of the technology disclosed herein.

FIG. 2 is an elevational view of the solar thermal processing system of FIG. 1, depicted from the heliostat array, and facing the front of the roasting chamber subassembly.

FIG. 3 is a perspective view of a first embodiment rotatable hollow chamber used for processing agricultural products, in the system of FIG. 1.

FIG. 4 is a front, elevational view of the first embodiment rotatable hollow chamber of FIG. 3.

FIG. 5 is a side, elevational view of the first embodiment rotatable hollow chamber of FIG. 3.

FIG. 6 is a perspective view of a pair of vertical supports used for mounting the first embodiment rotatable hollow chamber of FIG. 3.

FIG. 7 is a front, elevational view of the pair of vertical supports of FIG. 6.

FIG. 8 is a side, elevational view of one of the vertical supports of FIG. 6.

FIG. 9 is a perspective view of the first embodiment rotatable hollow chamber subassembly of FIG. 3, illustrating its axis of rotation.

FIG. 10 is a is a perspective view of a second embodiment rotatable hollow chamber used for processing agricultural products, in the system of FIG. 1.

FIG. 11 is a side, elevational view of the second embodiment rotatable hollow chamber of FIG. 10.

FIG. 12 is a front, elevational view of the second embodiment rotatable hollow chamber of FIG. 10.

FIG. 13 is a front, cutaway view of the second embodiment rotatable hollow chamber of FIG. 10, taken along a section line through its vertical centerline.

FIG. 14 is a perspective view of a mounting bracket subassembly used for mounting the second embodiment rotatable hollow chamber of FIG. 10.

FIG. 15 is a top, plan view of the mounting bracket subassembly of FIG. 14.

FIG. 16 is a side, elevational view of the mounting bracket subassembly of FIG. 14.

FIG. 17 is a front, elevational view of the mounting bracket subassembly of FIG. 14.

FIG. 18A is a perspective view of the second embodiment rotatable hollow chamber subassembly of FIG. 10, illustrating its two axes of rotation, at a non-tilted attitude along its primary axis, and at a non-rotated attitude along its secondary axis.

FIG. 18B is a perspective view of the second embodiment rotatable hollow chamber subassembly of FIG. 10, illustrating its two axes of rotation, at a non-tilted attitude along its primary axis, and at a rotated attitude along its secondary axis.

FIG. 19 is a perspective view of the second embodiment rotatable hollow chamber subassembly of FIG. 10, illustrating its two axes of rotation, at both a tilted attitude along its primary axis, and at a rotated attitude along its secondary axis.

FIG. 20 is a perspective view of a set (subassembly) of adjustable louvers that may be used in the roasting chamber subassembly of FIG. 2, illustrating the louver blades in a closed position.

FIG. 21 is a perspective view of the set (subassembly) of louvers of FIG. 20, illustrating the louver blades in an open position.

FIG. 22 is a front, elevational view of the set (subassembly) of louvers of FIG. 20, illustrating the louver blades in the closed position.

FIG. 23 is a block diagram of some of the major components used in the control system of the solar thermal processing system of FIG. 1, including an ARRAY SYSTEM CONTROLLER and a CHAMBER SYSTEM CONTROLLER.

FIG. 24 is a flow chart showing some of the functions performed by the control system for the solar thermal processing system of FIG. 1.

FIG. 25 is a perspective view of a cooling tray subassembly used in the solar thermal processing system of FIG. 1.

FIG. 26 is perspective view of the major components of a solar thermal processing system for use in processing agricultural products, similar to FIG. 1, but showing the heliostats aiming at the opposite hollow chamber.

FIG. 27 is an elevational view of the solar thermal processing system of FIG. 26, as depicted from the heliostat array, and facing the front of the roasting chamber subassembly.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” or “mounted,” and variations thereof herein are used broadly and encompass direct and indirect connections, couplings, or mountings. In addition, the terms “connected” or “coupled” and variations thereof are not restricted to physical or mechanical connections or couplings. Furthermore, the terms “communicating with” or “in communications with” refer to two different physical or virtual elements that somehow pass signals or information between each other, whether that transfer of signals or information is direct or whether there are additional physical or virtual elements therebetween that are also involved in that passing of signals or information. Moreover, the term “in communication with” can also refer to a mechanical, hydraulic, or pneumatic system in which one end (a “first end”) of the “communication” may be the “cause” of a certain impetus to occur (such as a mechanical movement, or a hydraulic or pneumatic change of state) and the other end (a “second end”) of the “communication” may receive the “effect” of that movement/change of state, whether there are intermediate components between the “first end” and the “second end,” or not. If a product has moving parts that rely on magnetic fields, or somehow detects a change in a magnetic field, or if data is passed from one electronic device to another by use of a magnetic field, then one could refer to those situations as items that are “in magnetic communication with” each other, in which one end of the “communication” may induce a magnetic field, and the other end may receive that magnetic field, and be acted on (or otherwise affected) by that magnetic field.

The terms “first” or “second” preceding an element name, e.g., first inlet, second inlet, etc., are used for identification purposes to distinguish between similar or related elements, results or concepts, and are not intended to necessarily imply order, nor are the terms “first” or “second” intended to preclude the inclusion of additional similar or related elements, results or concepts, unless otherwise indicated.

In addition, it should be understood that embodiments disclosed herein include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the electronic based aspects of the technology disclosed herein may be implemented in software. As such, it should be noted that a plurality of hardware and software-based devices, as well as a plurality of different structural components may be utilized to implement the technology disclosed herein. Furthermore, if software is utilized, then the processing circuit that executes such software can be of a general purpose computer, while fulfilling all the functions that otherwise might be executed by a special purpose computer that could be designed for specifically implementing this technology.

It will be understood that the term “circuit” as used herein can represent an actual electronic circuit, such as an integrated circuit chip (or a portion thereof), or it can represent a function that is performed by a processing circuit, such as a microprocessor or an ASIC that includes a logic state machine or another form of processing element (including a sequential processing circuit). A specific type of circuit could be an analog circuit or a digital circuit of some type, although such a circuit possibly could be implemented in software by a logic state machine or a sequential processor. In other words, if a processing circuit is used to perform a desired function used in the technology disclosed herein (such as a demodulation function), then there might not be a specific “circuit” that could be called a “demodulation circuit;” however, there would be a demodulation “function” that is performed by the software. All of these possibilities are contemplated by the inventors, and are within the principles of the technology when discussing a “circuit.”

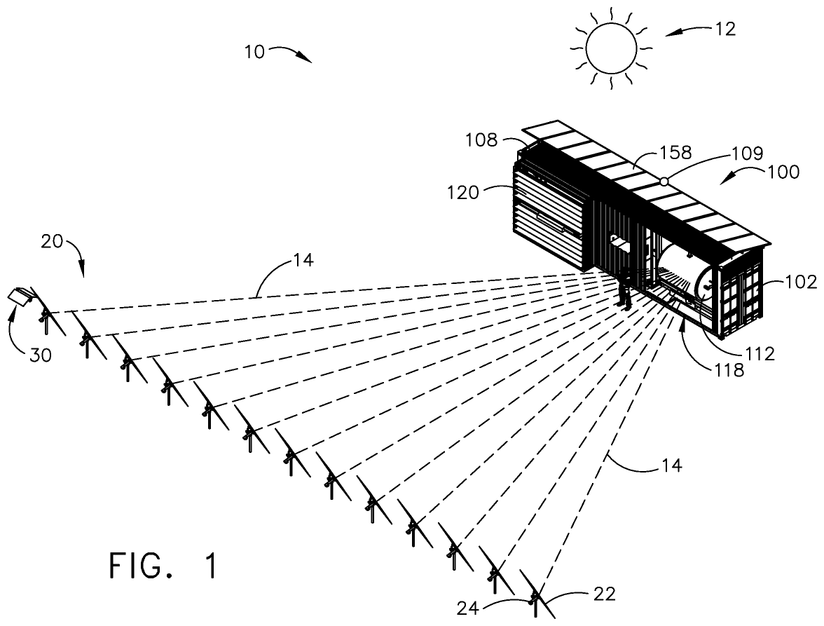

Referring now to FIG. 1, an example of an entire solar thermal processing system for use with processing agricultural products is generally depicted by the reference numeral 10. The processing system 10 includes an array 20 of heliostats that can be aimed at a roasting subassembly or ‘system’ 100 which, when the sun 12 is shining on the heliostats, will heat a hollow chamber 112. As can be seen in FIG. 1, the roasting system 100 includes an enclosure having a side wall 102 and a roof 108, in which the roof includes a number of solar panels 158 for providing electrical power to the electrical and electronic devices that are also included in the roasting system 100. In general, each hollow chamber 112 will have a cooling (or unloading) area 118 that typically is located directly beneath that chamber 112.

In the illustrated embodiment of FIG. 1, there are two different hollow chambers 112; the first one that is visible in this view, and a second one that is behind a set of adjustable louver blades 120 (i.e., a first louver subassembly 128). If these optional louvers are used in an actual system, then there preferably would also be a second set of adjustable louver blades 120 (i.e., a second louver subassembly 128) mounted in front of the right-hand hollow chamber 112, but that second set of louvers has been removed in this view, for clarity purposes.

It will be understood that the use of these louvers 128 is optional, and an open space, or an optically clear window could be provided, instead of any louvers at all. However, for this Detailed Description, the provision of the louvers 128 will be described herein as if they are an integral part of the overall heating system, and also illustrated on the corresponding drawings.

The array 20 of heliostats comprises many individual heliostats 22, which each have an aiming actuator 24. Each heliostat can thereby be individually aimed at a somewhat different area on the surface of the hollow chamber 112. As illustrated, each heliostat 22 can be commanded to aim a reflected beam of radiant solar energy 14 (i.e., electromagnetic photons that originated in the sun 12) onto multiple different areas of the hollow chamber 112.

In an optional mode of operation, the louver blades 120 could be open for only one of the two hollow chambers 112 at a given moment, and the louver blades for the other one of the hollow chambers could be closed, to allow the contents in the other hollow chamber to cool, as desired. Alternatively, the heliostats could all be aimed elsewhere, to achieve a similar, desired cooling effect. Furthermore, if optionally desired, both sets (subassemblies) of louvers 128 could simultaneously be opened to allow radiant solar energy to be aimed at (and thus strike) both hollow chambers 112. This would divide the amount of radiant solar energy being made available to each hollow chamber, of course, so this optional mode of operation would typically be considered unusual.

The array 20 of heliostats will also include the “Array System Controller” 30, which is illustrated on FIG. 1 as being positioned physically near the heliostats. However, the Array System Controller 30 could theoretically be positioned almost anywhere, so long there would be some type of communications pathway between the system controller 30 and the array 20. In general, it nominally would be desirable for each individual heliostat 22 to be relatively ‘self-guiding’ so that the system controller 30 would only need to tell the heliostat array 22 to “AIM NOW” at one of the two hollow chambers 112. Moreover, if the individual heliostats are to be relatively ‘self-guiding,’ that would also mean that they would need to have sufficient intelligence to be able to ‘find’ the sun 12. Such individual controllers are commercially available, but they would always need to be told ‘where’ the nominal target is—i.e., either the ‘left-hand’ or ‘right-hand’ hollow chamber. That knowledge would come from the Array System Controller 30.

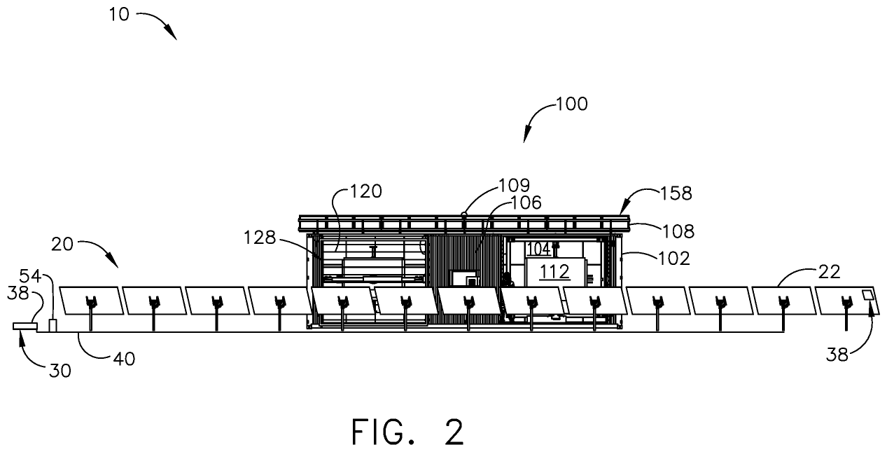

Referring now to FIG. 2, the entire solar thermal processing system 10 is again illustrated essentially from ground level, behind the array 20 of heliostats. In this view, a few additional structural elements can be seen, such as the back wall 104 of the enclosure for the hollow chambers, and an actuator 122 for the louver blades 120. A middle front wall of the enclosure is indicated at reference numeral 106. In this view, the louver blades 120 for the ‘left-hand’ hollow chamber are open, while the louvers for the ‘right-hand’ hollow chamber are removed for clarification purposes. In this view, it can be seen that the solar panels 158 are mounted above the roof structure 108.

In an exemplary design, there are twelve (12) solar panels 158, each being a QCell 480 Watt solar panel. The solar panel 38, in an exemplary design, comprises a pair of Renogy 100 Watt solar panels. In an exemplary design in which each heliostat mirror is two square meters in area, each heliostat 22 provides 2000 Watts of solar heat under standard test conditions (STC), as defined by IEC 60904-3. Also, each heliostat may optionally include its own individual solar panel (e.g., at reference numeral 38 on FIG. 1) for providing electrical power to its aiming control system.

Also in this view of FIG. 2, the field wiring between the individual heliostats is illustrated at reference numeral 40. This field wiring 40 is also connected to the Array System Controller 30, which has its own solar panel 38. This, of course, assumes that the Array System Controller 30 is not remotely located. And, for example, if it was desired by the systems engineer to use a remotely-located Array System Controller 30, then at least a radio would need to be added with the solar panel 38, and then connected to the field wiring 40 so that it could pass signals to the heliostats in the form of commands, as will be discussed below in greater detail.

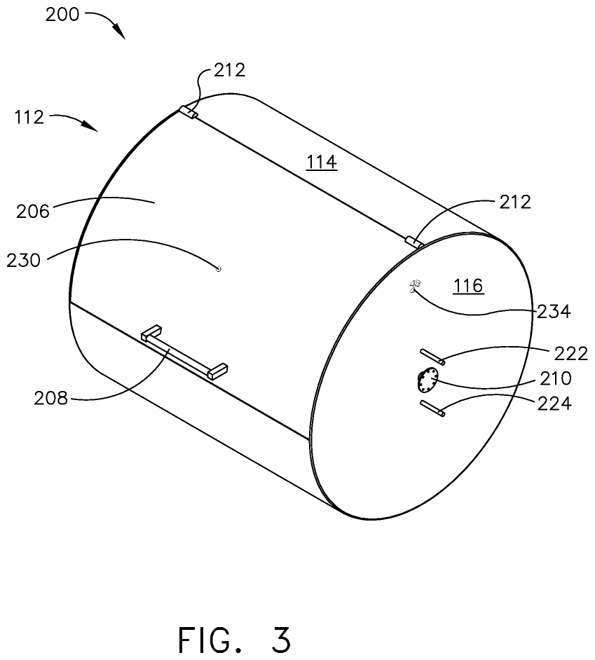

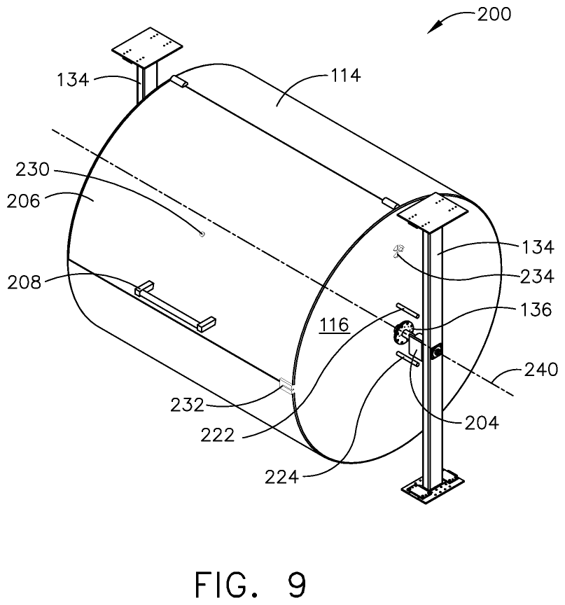

Referring now to FIG. 3, one of the hollow chambers is illustrated, and generally designated by the reference numeral 112. This hollow chamber 112 is a “first embodiment” chamber 200, and is designed to rotate in a single axis (see FIG. 9). There are structural features that are common between this “first embodiment” chamber 200 and a “second embodiment” chamber 300—see FIG. 10—and those common features will now be described. Both types of chambers are generally shaped like a drum, in the form of an elongated cylinder. Both types of chambers include an outer substantially cylindrical surface at 114, and both types of chambers include a pair of outer side walls 116 that exhibit a substantially flat surface. These side walls 116 are generally circular in shape.

Some of the exclusive features of the “first embodiment” chamber 200 will now be described. Chamber 200 is designed to rotate about a (generally horizontal) axis that intersects a center of the circular side wall 116. In this first embodiment, there is a mounting plate 210 at that center, on both side walls. (Another structure will be attached to those two side plates 210.) Chamber 200 also includes a door (or lid) 206, that is designed to open to allow agricultural products to be placed into the hollow interior space of the chamber 200, or to be removed from that hollow space. A pair of door hinges 212 are located along one of the outer edges of the door 206. The door (or lid) 206 is preferably designed to swing open, and to be secured shut, for quick loading and unloading of agricultural products.

Also seen in this view are two sensors: a humidity sensor 222 and a temperature sensor 224, that may optionally be provided with the chamber 200. It will be understood that these sensors could be mounted at different locations on the chamber 200 without substantially changing the overall operability of this structure, and further, additional sensors could also be mounted in this structure, if designed by the design engineer.

It will be understood that any number of hollow chambers 112 could be installed at a given location, from a single such chamber to multiple groups. However, if only a single such chamber 112 is provided at a given installation, then by itself, it would not be able to provide both a first ‘cooling’ chamber while a second such chamber was simultaneously being heated, but it could nevertheless be constructed, if desired. Each individual hollow chamber 112 would typically alternate between heating and cooling modes of operation.

Of course, any larger number of such chambers 112 could be used at a single installation, if desired. However, there would need to be physical space made available to not only locate the chambers on that jobsite, but also to locate the necessary array(s) of heliostats that could be aimed at those multiple chambers.

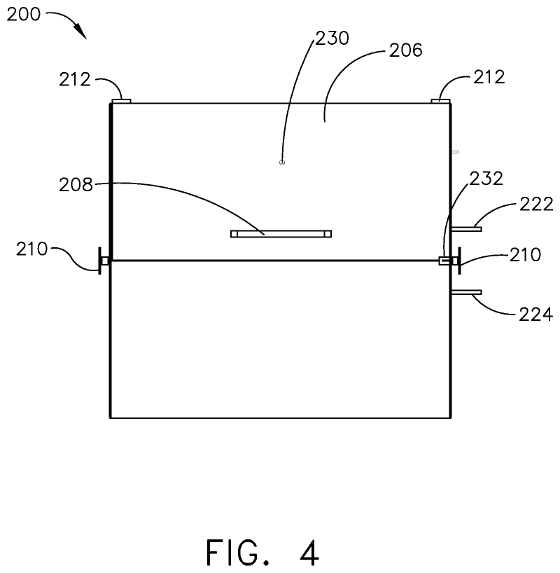

Referring now to FIG. 4, the hollow chamber 200 is again illustrated from its front, showing its typical horizontal mounting configuration. The same structures are again depicted in this view, with the addition of the second center mounting plate 210 at the second side wall 116.

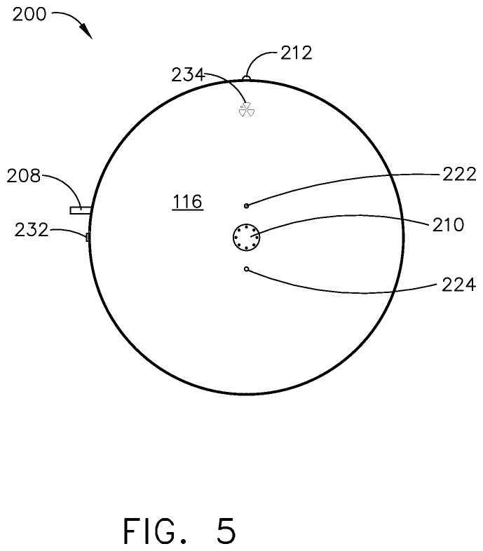

Referring now to FIG. 5, the hollow chamber 200 is again illustrated, this time from one of its sides or ends. In this view, the optional sensors 222 and 224 are seen, mounted near the center mounting plate 210. The substantially circular shape of the side wall 116 is plainly depicted in this view. An exemplary humidity sensor is a probe-type TE Connectivity model HPP809A031; an exemplary temperature sensor is a thermocouple probe-type FireBoard model SF2K.

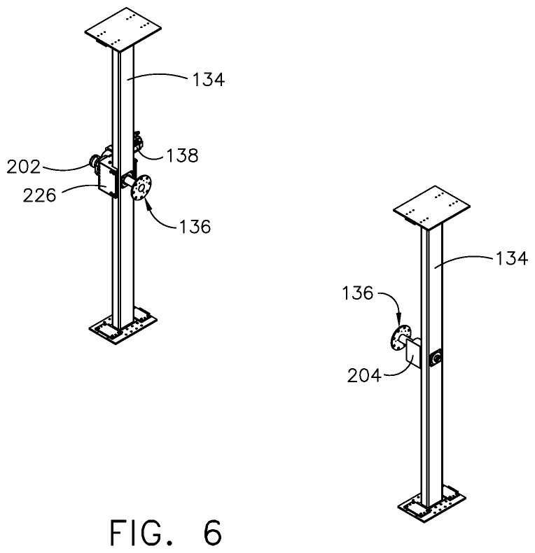

Referring now to FIG. 6, a pair of vertical supports 134 is depicted. Each support 134 includes a side mounting plate 136 that is designed to mate to the two center mounting plates 210 of the hollow chamber 200. The mounting plates 136 are illustrated as comprising bolt plates having a series of openings for receiving bolts used to mount the hollow chamber 200 thereto. Both side mounting plates 136 are able to rotate—as explained below—which will cause the entire hollow chamber 200 to rotate, when desired.

A servo motor system 138 is mounted near the “left” support's side mounting plate 136 which, when energized, will cause rotation of that “left” side mounting plate. This motion travels through a gearbox 202. A position sensor 226 is typically mounted to the gearbox 202, for system rotational control purposes. An optional rotational velocity sensor 228 can also be included here, if desired by the design engineer. A slip ring 204 is mounted near the “right” support's side mounting plate 136, so as to pass electrical power and electrical signals to the rotational components of the hollow chamber 200. (This includes at least the humidity and temperature sensors, if they are provided.)

For this hollow chamber 200 system, an exemplary slip ring 204 is a Senring Custom Slip Ring. An exemplary gearbox 202 is a Nabtesco High Torque Gearbox model RH-500NA, with a positional sensor Hesai A110-OpticalSwitch. An exemplary servo motor system is an Anaheim 2 KW Servo Motor model KNC-PKS-FD432S-20. Other equivalent products could of course be used instead.

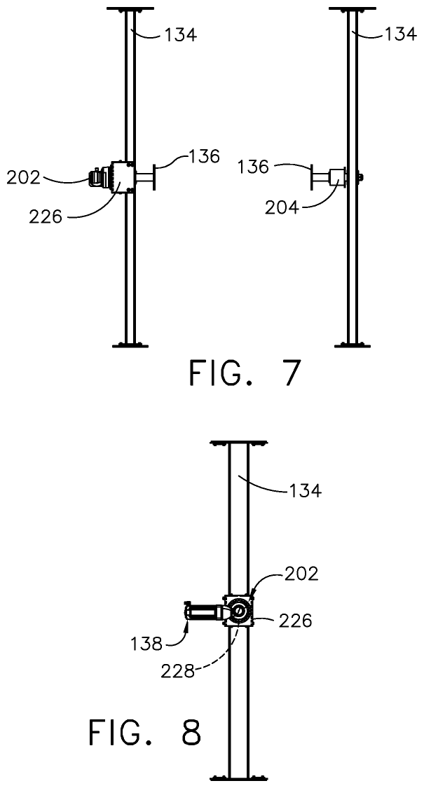

FIGS. 7 and 8 illustrate the vertical supports 134 in either a side view (FIG. 8) or in a front view (FIG. 7). The same components are illustrated here, as were described above, in reference to FIG. 6. As can be seen in FIG. 7, the two vertical supports are spaced-apart in their positions so as to be placed at the two mounting plates 210 of the rotatable hollow chamber 200.

Referring now to FIG. 9, the first embodiment chamber 200 is illustrated as a subassembly, mounted to the vertical supports 134, and in a manner that clearly shows its rotational axis at reference numeral 240. This first embodiment will also be sometimes referred to herein as a “single axis” hollow chamber. As would be expected, the hollow chamber 200 is movable about that single axis of rotation 240.

As an option, the chamber 200 may be supplied with a surface temperature sensor 230, for measuring the surface temperature of the outer metallic skin of the chamber 200. An exemplary sensor for this purpose is a bolt-on thermocouple, McMaster model 3648K24. Chamber 200 may also be provided with an actuating door release 232, such as an Adams Rite model 7200 Series “Electric Strike.” Further, chamber 200 will preferably include a vent 234, such as an adjustable vent plus a wire mesh (to prevent spills), of which an exemplary adjustable vent is a model SDTC Tech Ventilation Round Louver, TWP 304SS ¼ inch mesh.

Now referring to FIG. 10, a “second embodiment” hollow chamber is illustrated, generally depicted by the reference numeral 300. Chamber 300 still has the substantially flat side walls 116, and the overall cylindrical shape of a drum, including the substantially cylindrical surface 114. Two sensors, if provided, may be mounted in the side wall, at 322 and 324; but note, this side wall is removable.

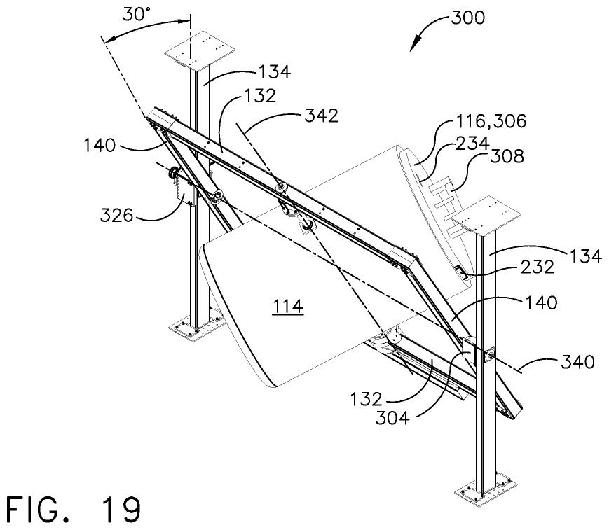

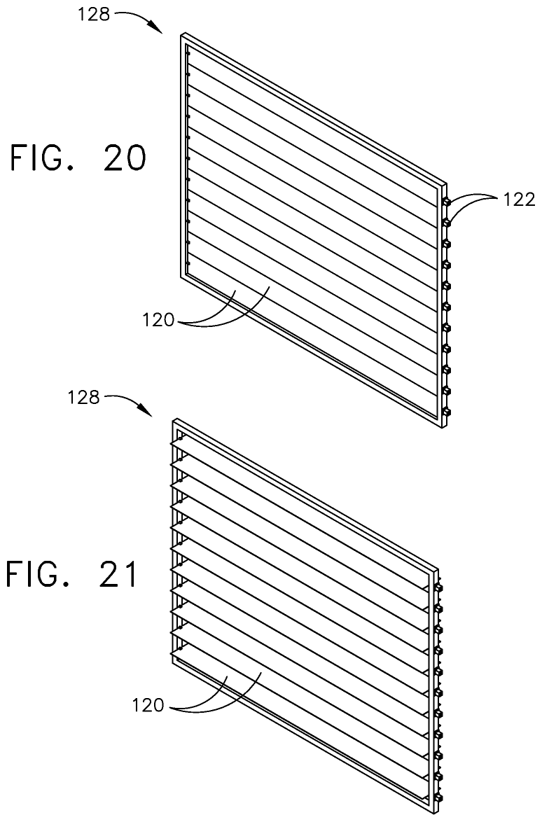

Some of the exclusive features of the “second embodiment” chamber 300 will now be described. Chamber 300 is designed to rotate about two different axes that are better illustrated in FIGS. 18A, 18B, and 19. In this second embodiment, there is no mounting plate at the side walls, but instead there are two ‘vertical’ pedestals 312 (with mounting plates) above and below (in this view) the main cylindrical surface 114. (Another structure will be attached to those mounting plates 312.)

Chamber 300 also includes a door (or lid) 306, that is designed to open (e.g., be removable) to allow agricultural products to be placed into the hollow interior space of the chamber 300, or to be removed from that hollow space. Instead of door hinges, there is a handle 308 that is attached to the door 306. As noted above, this second embodiment chamber 300 may include two sensors mounted in the door 306: a humidity sensor 322 and a temperature sensor 324. It will be understood that these sensors could be mounted at different locations on the chamber 300 without substantially changing the overall operability of this structure, and further, additional sensors could also be mounted in this structure, if designed by the design engineer.

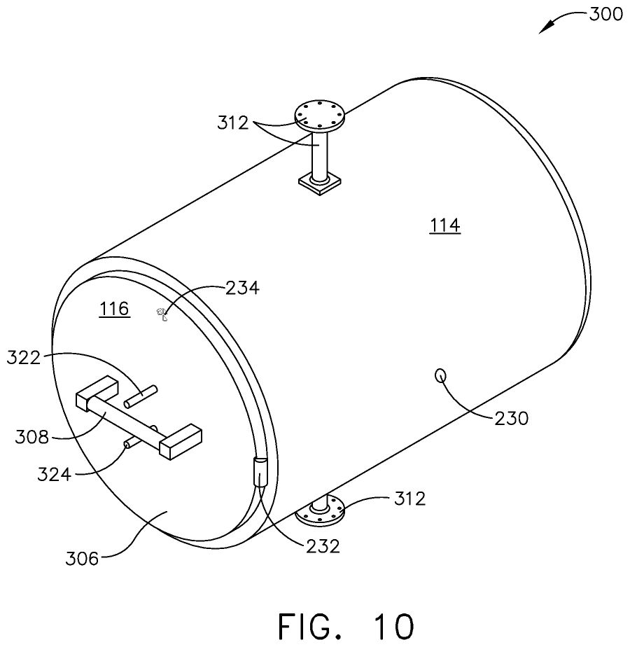

Referring now to FIG. 11, the hollow chamber 300 is again illustrated, from its right side or end. In this view, the optional sensors 322 and 324 are seen, mounted near the center area of the flat side wall 116. The substantially circular shape of the side wall 116 is plainly depicted in this view. The handle 308 is seen in this view, mounted along a horizontal (in this view) diameter of the circular (removable) side wall 116. The two pedestals/mounting plates 312 are seen in this view, one above and one below the main portion of hollow chamber 300, essentially along a vertical (in this view) centerline of the drum shape. The right side wall 116 is also the door 306 for this second embodiment hollow chamber 300.

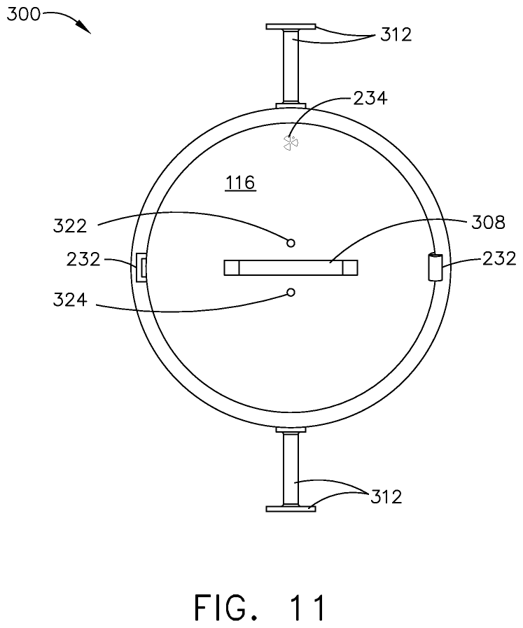

Referring now to FIG. 12, the hollow chamber 300 is again illustrated from its top, showing the upper pedestal/mounting plate 312. The same structures are again depicted in this view, with the addition of the second side wall 116. The handle 308 and the optional humidity sensor 322 are illustrated, mounted on the first side wall 116, which is also the movable door 306.

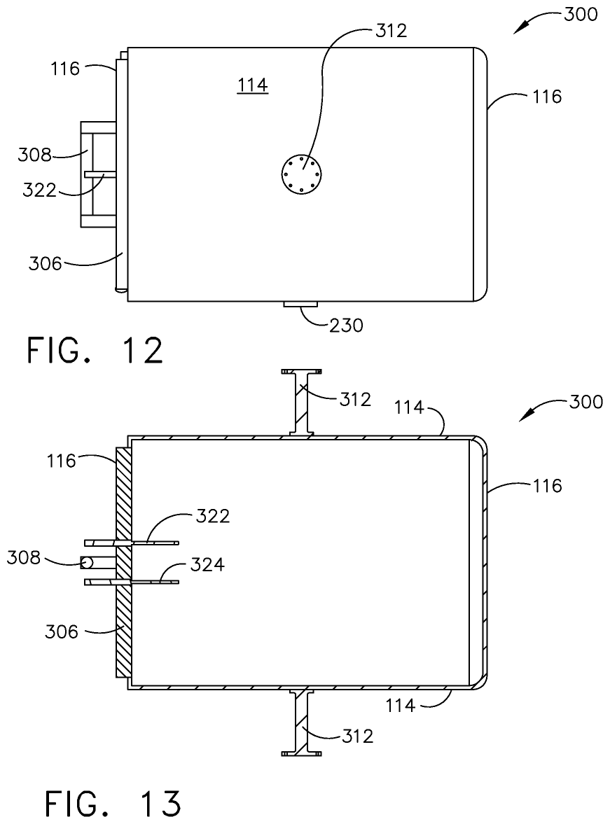

Referring now to FIG. 13, the hollow chamber 300 is again illustrated, this time as a cutaway view from its front side. Both vertical pedestals 312 are seen in this view, as are both side walls 116. The side wall on the left (in this view) is also the door 306. The two optional sensors 322 and 324 are depicted as penetrating from the exterior into the interior (hollow) portion of the hollow chamber 300. In this manner, these two sensors are able to detect the internal humidity and temperature of hollow chamber 300, which essentially will be the same as detecting the humidity and temperature of the agricultural product that is being processed within this chamber. An exemplary humidity sensor is a probe-type TE Connectivity model HPP809A031; an exemplary temperature sensor is a thermocouple probe-type FireBoard model SF2K.

Note that the processing duration for most agricultural products, especially such products that are being “roasted,” is generally measured in at least several minutes of time. Thus, the (somewhat slowly) changing temperature and humidity of the internal hollow space of this chamber 300 will essentially be equivalent to that of the agricultural product itself. Moreover, if the amount of the agricultural product being processed within this hollow chamber essentially fills that hollow internal space, then the sensors 322 and 324 (if provided) will likely be directly touching a portion of that agricultural product. Therefore, sensors 322 and 324 need to be relatively sturdy and robust devices so they can withstand such treatment, during normal use. (The same is true for the optional sensors 222 and 224 of the first embodiment hollow chamber 200, which will have a similar type of mounting for its sensors in the side wall 116.)

Referring now to FIG. 14, a pair of vertical supports 134 and a rectangular-shaped framework 130 are depicted. Each support 134 includes some type of rotational mounting device (discussed below) near its mid-length that attaches to the framework 130, so as to be able to tilt the framework 130. The framework itself comprises two vertical frame pieces 140 and two horizontal frame pieces 132 (as seen in this orientation). Each horizontal frame piece 132 includes some type of mounting plate at 314 or 316 (see below) near the mid-length of the frame pieces 132.

As will be discussed below in greater detail, the structural elements of the framework 130 will allow the hollow chamber 300 to be rotated in two different axes. The upper mounting plate at 316 is also a first slip ring that will allow electrical power and electrical signals to be passed to the rotational components of the hollow chamber 300. (This includes at least the humidity and temperature sensors.) The lower mounting plate at 314 is also a “secondary drivetrain” that includes a motor and a gearbox. The combination of the slip ring 316 and drivetrain 314 allows the hollow chamber 300 to be rotated along its ‘vertical’ axis (in this view), i.e., along a line that passes through the first slip ring 316 and drivetrain 314, regardless of their positional orientation. These components 314 and 316 also include bolt plates that are used for mounting the hollow chamber 300 thereto.

There is a second slip ring 304 between the right (in this view) vertical frame 140 and right vertical support 134, and a “primary drivetrain” 310 mounted to the left (in the view) vertical support 134 that produces a rotational movement between the left (in this view) vertical frame 140 and left vertical support 134. The combination of the second slip ring 304 and drivetrain 310 allows the entire framework 130 (with its attached hollow chamber 300) to be tilted (i.e., rotated) along its horizontal axis. (See FIG. 19 for more detail.) The primary drivetrain includes a servo motor system 138, a gearbox 302, and (typically) a position sensor 326 that is mounted to the gearbox 302, for system rotational control purposes. An optional rotational velocity sensor 328 can also be included here, if desired by the design engineer.

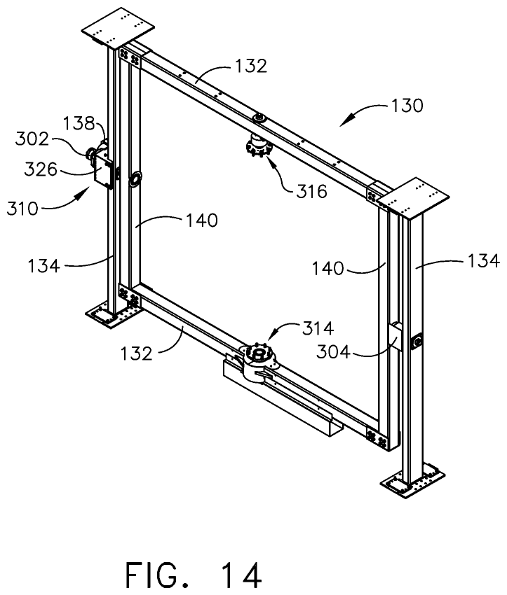

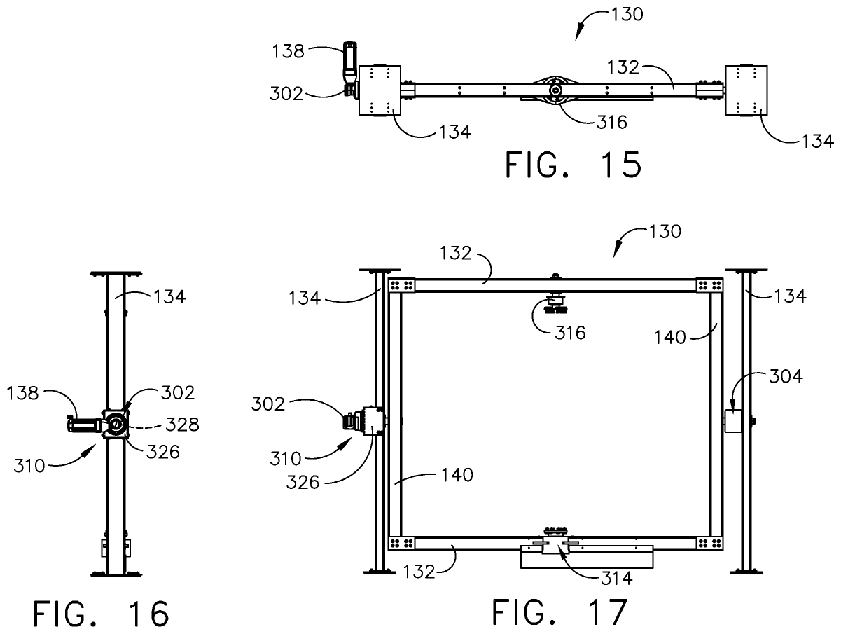

FIG. 15 illustrates the framework 130 from above, showing the two vertical supports 134, the top horizontal frame 132, the first slip ring 316, and the servo motor 138 and gearbox 302. FIG. 16 illustrates the framework 130 from the left side, showing the left vertical support 134, the “primary drivetrain” 310, which includes the servo motor 138, gearbox 302, the typical position sensor 326, and optional rotational velocity sensor 328.

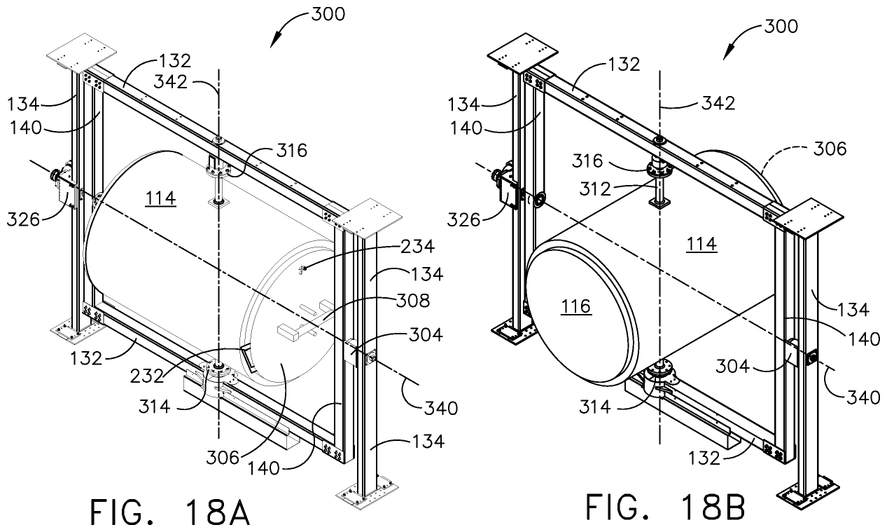

FIG. 17 illustrates the framework 130 in a front, elevational view, showing all the major components discussed above for the vertical supports 134, the framework pieces 132 and 140, the slip rings 304 and 316, and the primary and secondary drivetrains 310 and 314. The open space in the middle of the framework is, of course, where the hollow chamber 300 will be mounted.

For this hollow chamber 300 system, an exemplary slip ring (for both items 304 and 316) is a Senring Custom Slip Ring. An exemplary gearbox 302 is a Nabtesco High Torque Gearbox model RH-500NA, with a positional sensor Hesai A110-OpticalSwitch. An exemplary servo motor system is an Anaheim 2 KW Servo Motor model KNC-PKS-FD432S-20. Other equivalent products could of course be used instead. Note that both the primary drivetrain 310 and the secondary drivetrain 314 may be constructed from identical components in this illustrated embodiment.

Referring now to FIGS. 18A and 18B, the second embodiment chamber 300 is illustrated as a subassembly, mounted to the vertical supports 134 and the framework 130, in a manner that clearly shows its first rotational axis at reference numeral 340, and its second rotational axis at 342. This second embodiment will also be sometimes referred to herein as a “dual axes” hollow chamber. As would be expected, the hollow chamber 300 is movable about both of these axes of rotation 340 and 342. (The next view of FIG. 19 will show this more clearly.) In FIG. 18B, the chamber 300 has been rotated about its second axis 342, using the slip ring 316 and secondary drivetrain 314 that are connected to its two vertical pedestals 312. In FIG. 18A, the chamber 300 has not been rotated about either of its two axes 340 or 342. However, during a processing session (during which an agricultural product is being heated or ‘roasted’), the hollow chamber 300 would typically be rotated about at least its ‘primary axis’ 340, to keep the internal temperature substantially uniform. (See below for more information in the flow chart description.)

FIG. 19 illustrates the same hardware components as does FIG. 18, however, the chamber 300 has been rotated about both of its axes 340 and 342. As can be clearly seen in this view, the entire framework 130 is rotatable about the horizontally-oriented axis 340, which of course causes the chamber 300 to also be rotated (or tilted) about that same horizontally-oriented axis 340. As can be clearly understood from viewing FIG. 19, the door 306 may be tilted ‘up’ so as to easily load agricultural products that are about to be processed, or the door 306 may be tilted ‘down’ so as to easily remove (or ‘dump’) already processed agricultural products from the hollow chamber 300. In FIG. 19, the tilt angle of the primary axis from the vertical is about 30 degrees.

Referring now to FIG. 20, one of the optional sets (subassemblies 128) of adjustable louvers is illustrated. The individual ‘blades’ or ‘slats’ of the louvers is depicted at the reference numeral 120, while a multitude of individual louver actuators is depicted at the reference numeral 122. In FIG. 20, the louvers are shown in a closed position. FIG. 21 shows the same set of louvers 128, and in the same perspective, but the louver blades are shown in an open position. Note that the louvers are preferably designed so as to be adjustable to any angle between zero (0) degrees to 180 degrees, to allow either more or less solar radiant power to the hollow chambers. In general, the louvers 128 are designed to control an amount of visible electromagnetic energy that is permitted to strike a surface of the at least one rotatable hollow chamber 112, and in particular, to control the amount of reflected radiant solar energy being aimed by the array of heliostats 20.

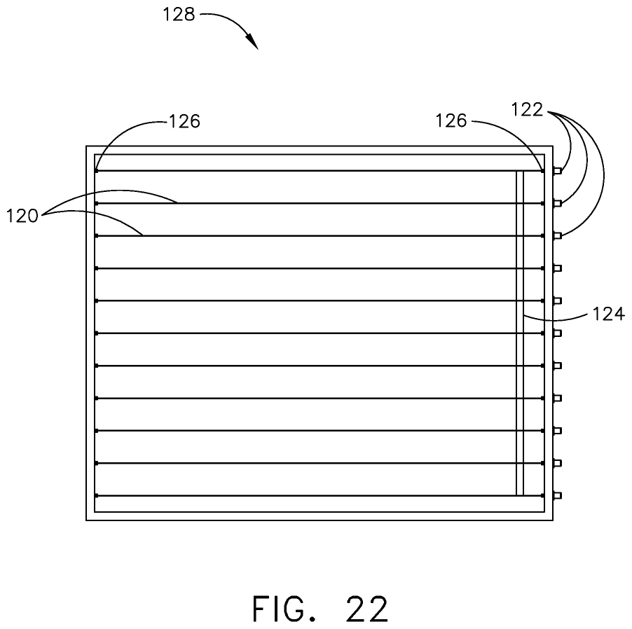

FIG. 22 shows a set (subassembly) of louvers 128 in a front, elevational view, with the louver blades in an open position. Furthermore, a linkage 124 is included so as to be able actuate all the individual louver blades simultaneously from a single louver actuator (as an optional feature), instead of using multiple direct-drive motors 122. Each louver blade has a bearing 126 on each end, as illustrated; an exemplary greased sleeve bearing is a Bunting Bearing model 16BU24. An exemplary actuator 122 is a SureStep stepper motor model STP-MTRH-34097W.

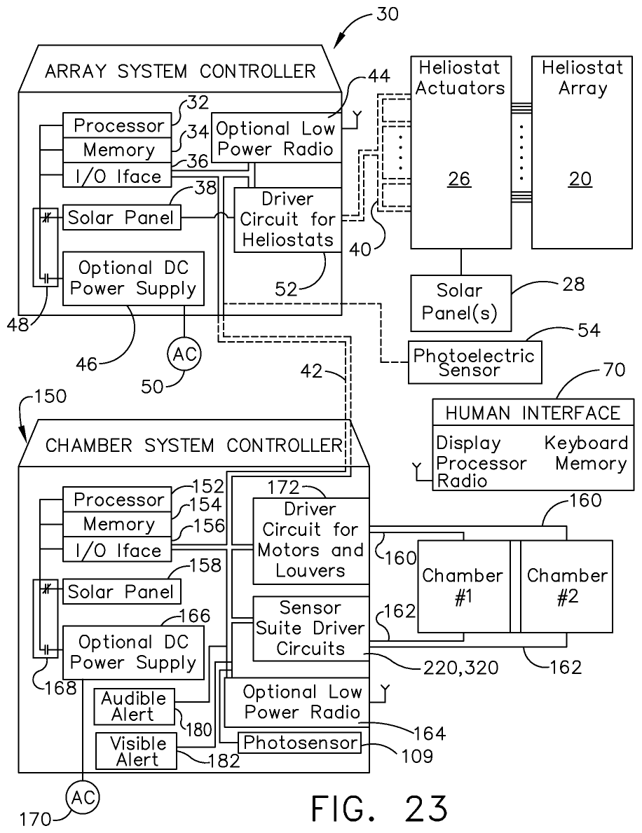

Referring now to FIG. 23, a system block diagram is provided showing some of the major electrical and electronic components of the solar thermal processing system 10. The major subsystems are indicated, including an Array System Controller 30, a Chamber System Controller 150, the heliostat array 20 and its aiming actuators 24 (referred to as a group by the reference numeral 26), and a “human interface” computer 70.

The Array System Controller 30 would typically be located relatively close in physical proximity to the heliostat array 20 and that array's group of aiming actuators 26, and field wiring 40 typically would be used to electrically connect Array System Controller 30 to those individual aiming actuators 24. The Chamber System Controller 150 would typically be mounted somewhere in the enclosure of the roasting system 100, with power wiring 160 strung between the Chamber System Controller 150 and the various motors used in the roasting system 100, and with signal wiring 162 also strung between the Chamber System Controller 150 and the various sensors that may be used in the roasting system 100. There would also need to be some type of communications circuits between the Array System Controller 30 and the Chamber System Controller 150; this is depicted on FIG. 23 as field wiring 42, which assumes there would be hard wiring between those two system controllers 30 and 150. However, as an option, it also would be possible for such communications commands and status messages to instead be passed wirelessly, using optional low power radios 44 and 164, if desired.

Generally speaking, it is desirable for there to be some type of “human interface” 70 to be provided with this overall solar thermal processing system 10, to input commands (such as, “Start processing Batch #5 in chamber #2 at 0915 hours on Jul. 23, 2023”) and to receive status messages (such as, “Batch #5 is finished processing at 0333 hours on Jul. 23, 2023”). It is expected that production reports and production scheduling would all be performed using the human interface 70. Furthermore, the human interface could optionally be used to manually control the number of heliostats that are aimed at a hollow chamber for a roasting cycle of a predetermined time duration.

A typical such human interface computer 70 could be constructed as a standard commercial device, such as a wireless laptop or tablet computer, a wired (or wireless) desktop computer, or an Internet-compatible or Bluetooth-compatible cellular telephone (or “smart phone”), for example. If the physical location of the solar thermal processing system 10 is fairly remote, there may not be any cellular or Wi-Fi communications links available, and that fact could essentially specify what type of human interface device should be used. Moreover, there may not be any AC electrical power available, either, and thus, all electronic equipment on site would need to be either battery-powered or solar-powered.

Finally, assuming at least some type of Internet link would be available at the site of the solar thermal processing system 10, the human interface computer 70 could perhaps be completely remote—i.e., miles away, and communicating solely through the Internet to a wireless transponder (not shown on FIG. 23) that is able to communicate with the low power radios 44 and 164. In any event, the human interface computer 70 would preferably include its own processing circuit, memory circuit (storing instructions to be executed by the processing circuit of 70), a display so the human user could monitor the system status, a keyboard so the human user could enter commands and/or send messages to the system controllers 30 and 150 (if desired), and a radio communications circuit so (as noted above) the human user could literally be remotely located from the jobsite of the system 10, but still be able to communicate with system 10 (e.g., over the Internet). Moreover, the human user computer 70 alternatively could be physically located at the same jobsite as the solar thermal processing system 10, but nevertheless could remain electrically isolated from the system controllers 30 and 150 by using radio communications. Note that the human user could also perform manual control of the heliostats, if desired.

The Array System Controller 30 includes at least a processing circuit 32, a memory circuit 34, and an input/output interface circuit 36, and possible a display (not shown) to display status messages on site. The Array System Controller 30 also has a signal and/or data bus that transfers signals from the I/O interface 36 to the optional low power radio 44, to a driver circuit 52 that sends control signals to the group of aiming actuators 26 for the array of heliostats 20, and also to the field wiring 42 (if used) between the two system controllers 30 and 150. A solar panel 38 will typically be provided to supply electrical power to the Array System Controller 30. Furthermore, an optional AC power source 50 could be used, if one is available at this jobsite location. If AC power is available, then a DC power supply 46 would typically be provided, along with a power switch 48 that will either connect the AC power source 50, or the solar panel power source 38 to the overall control system.

As briefly discussed above, there preferably will be at least one solar panel 28 installed to power the group of heliostat-aiming actuators 26. There also could be individual solar panels mounted on each heliostat (as per reference numeral 38 on FIG. 2).

Note that the field wiring 40 between the Array System Controller 30 and the multiple heliostat-aiming actuators 26 could comprise individual wires for each individual heliostat-aiming actuator; or alternatively, a multiplexer (not shown) could be used for the group of heliostat-aiming actuators 26. If a multiplexer is used at the processing circuit 32, then command signals from the Array System Controller 30 could travel over a much smaller number of wires to the multiplexer located near the group of heliostat-aiming actuators 26, at which time the commands are to be “de-muxed” into individual output (command) signals connected to wires that then travel to the individual heliostat-aiming actuators 24. Assuming that it will be desirable to have status signals sent from the individual heliostat-aiming actuators 24 back to the Array System Controller 30, then a second set of multiplexers could be used to reduce the wire count for the field wiring 40, for delivering those status signals to the Array System Controller 30.

It will be understood that the processing circuit 32 could be constructed as a standard commercial microprocessor or microcontroller device, of which there are many that could be used for the purposes of the Array System Controller 30. A microcontroller would likely be the device of choice for this application, since most microcontrollers today include on-board memory elements, clock circuits, and an analog-to-digital (A/D) converter. The I/O Interface circuit 36 could also perhaps be on-board the microcontroller, depending on the exact types of sensors being used in the hollow chambers 112. For example, some sensors may provide a voltage output, while others may provide a current output (such as 4-20 mA); also, different types of temperature sensors require very different types of interface circuits, and therefore, a separate I/O Interface circuit (off-board the microcontroller) may well be needed here. Furthermore, the optional low power radio 44 may have its own unique interface requirement, if used in this system.

The Chamber System Controller 150 includes at least a processing circuit 152, a memory circuit 154, and an input/output interface circuit 156, and possible a display (not shown) to display status messages on site. The Chamber System Controller 150 also has a signal and/or data bus that transfers signals from the I/O interface 156 to the optional low power radio 164, to a driver circuit 172 that sends control signals (over wires 160) to the motors and louver actuators 122 for the two hollow chambers, and receives signals (over wires 162) from the various optional sensors for the two hollow chambers, using driver circuits 220, 320 for the two sensor suites. This signal/data bus also connects to the field wiring 42 (if used) between the two system controllers 30 and 150.

A relatively large set of solar panels 158 will typically be provided to supply electrical power to the Chamber System Controller 30, which essentially includes the power needed for the various motors and other actuators in the chamber system. Furthermore, an optional AC power source 170 could be used, if one is available at this jobsite location. If AC power is available, then a DC power supply 166 would typically be provided, along with a power crossover switch 168 that will either connect the AC power source 170, or the solar panel power source 158 to the overall control system.

It will be understood that the processing circuit 152 could be constructed as a standard commercial microprocessor or microcontroller device, of which there are many that could be used for the purposes of the Chamber System Controller 150. A microcontroller would likely be the device of choice for this application, since most microcontrollers today include on-board memory elements, clock circuits, and an analog-to-digital (A/D) converter.

The I/O Interface circuit 156 could also perhaps be on-board the microcontroller, depending on the exact types of sensors being used in the hollow chambers 112. For example, some sensors may provide a voltage output, while others may provide a current output (such as 4-20 mA); also, different types of temperature sensors require very different types of interface circuits, and therefore, a separate I/O Interface circuit (off-board the microcontroller) may, again, be needed here. Furthermore, the optional low power radio 164 may have its own unique interface requirement, if used in this system.

### Typical System Configuration

The solar thermal processing system 10 is designed to be typically used for processing agricultural products, and one typical use would be for coffee roasting, or roasting other types of beans or nuts, and similar applications. As described above, such a system would include an array of sun-tracking heliostats 20, which can keep reflected light on a selected target. The heliostats may incorporate an ordinary ‘flat’ mirror, on one with focus to increase heat intensity on a target. The heliostats could store several pre-identified ‘targets’ such as: (1) a first agricultural processing system, (2) a ‘safe’ or ‘stand-by’ position, or perhaps (3) a second agricultural processing system.

The number of heliostats in a given system can be adjusted to suit the needs of the process for that installation. If a greater amount of heat is required than typical, then additional heliostats would be installed at that jobsite. Further, the size of the heliostat mirrors can also be adjusted to suit the needs of the process, so that larger mirrors could be installed, if desired, instead of (or in addition to) installing a greater number of mirrors.

The heliostats 20 need to have the ability to track the Sun, as the Earth rotates. A single-axis Sun tracking mirror could be used; however, a dual-axis tracking mirror is preferred, especially depending on the latitude of the jobsite installation. The tracking hardware will typically use an on-board microprocessor to perform math needed to correct for sun movement across the sky, and keep light reflected onto a selected target. The tracking control may be centralized (i.e., a single computer controlling many reflectors) or distributed (i.e., where each mirror system is controlled by a dedicated microprocessor). The individual heliostat-aiming actuators 24 are connected to a wired or wireless network to receive commands (e.g., using the field wiring 40).

The Array System Controller 30 will preferably be microprocessor based, as described above. This control system will ‘trigger’ the heliostats to move on and off target as needed in response to operator inputs (e.g., a command to ‘start roasting process’, or to ‘stop roasting process,’ etc.). The array control system may also receive data from the heliostats (e.g., information about their current position), and also from the Chamber System Controller 150 (e.g., sensor data, if provided, such as temperature, moisture content, etc.).

The roasting container (i.e., the hollow chamber 112) will typically be a cylinder or other shaped hollow container made of metal, or other heat conductive material. As described above, the hollow chamber 112 preferably is motorized to rotate in one axis, or two axes. The rotating speed preferably is variable, and microprocessor controlled. The processing circuit 152 will execute instructions (e.g., on-board code) that are stored in the memory circuit 154, including storing instructions about preferred movement patterns or preferred agricultural product processing information.

In the illustrated embodiments, there are two hollow chambers 112 per installation, which are ‘networked’ to communicate with the Chamber System Controller 150. The hollow chambers 112 typically will include sensors (e.g., to measure temperature, humidity, color, etc.) mounted inside or outside the container. Fans (not shown) may be mounted externally to the hollow chambers 112 to blow cooling air over the container for temperature regulation. The hollow chambers 112 may contain a remote-controlled hatch (e.g., the door 206) that could allow the processed agricultural product (e.g., coffee) to pour out quickly. The hollow chambers 112 may also contain one or more remotely-operated vents (not shown) to allow hot gasses to escape, during processing.

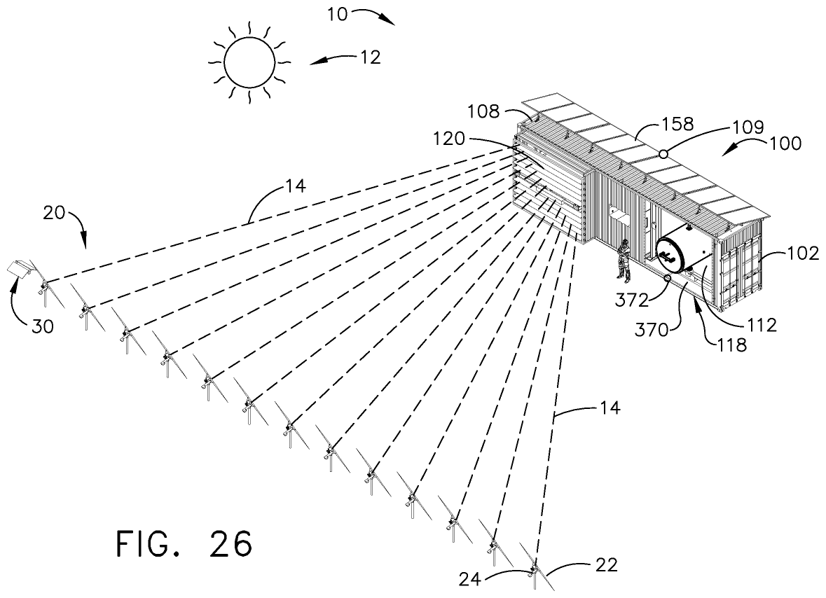

Referring now to FIG. 25, a ventilated open-top cooling tray subassembly 348 with a perforated metal base 350 may be provided, along with an array of fans 354 blowing air upwards through the perforations (openings 356) in the metal base 350 of the cooling tray. An optional stirring paddle 352 may be included to mix and distribute the agricultural product (e.g., coffee beans), as needed. A temperature sensor 362, such as an infrared sensor, may be provided (if desired) to detect the temperature of the agricultural product (e.g., coffee-beans) resting on the cooling tray 348, such as a model MLX90640 infrared temperature sensor. The agricultural product temperature data can be sent to the Chamber System Controller 150.

The cooling tray subassembly 348 can be provided with some type of adjustable mounting stand or mounting legs. For example, scissor-type legs 360 could be used, having the ability to raise or lower the cooling tray 348, so the tray will fit beneath one of the rotating hollow chambers 112. Other types of cooling areas 118 may be provided, as discussed below.

### Batch System

The processing of agricultural products could be performed in two major types of processes: a “Batch System” or a “Continuous Flow System.” An exemplary Batch Processing System will now be described. The ‘target’ for the heliostats is the agricultural processing system that includes at least one hollow metal container or chamber 112, which is mounted to a machine capable of rotating the chamber in one axis or in two axes.

As described above, the chamber may be equipped with sensors (e.g., sensor suite 220), perhaps including sensors to measure the inside air temperature of the chamber, the skin temperature of the chamber, and/or the humidity of the inside air. The chamber may further be equipped with an electronically-triggered lid 206 for remote opening. The roasting system installation 100 may include an electronically-adjusted louver 128 or similar system, which can quickly adjust the amount of light passing through the louver from 0% to 100% or any value therebetween.

A system controller 150 typically is included, which may be a small computer (or microcontroller) able to take in data from the various optional sensors, and send out commands to vary the speed of rotation of the chamber (in each axis independently), command one or more heliostats to direct heat to the chamber, command one or more heliostats to return to the non-heating/stand-by position, move the chamber to an unloading position, trigger the chamber lid to open, turn on or off cooling fans, and open or close the louver system 128 to reduce or increase the light/heat energy passing to the chamber from the heliostats.

The system controller 150 will typically have stored programs in its memory circuit 154, which feed data from the sensors into algorithms that send commands as described above, to achieve a specific pattern of heating; e.g., by controlling parameters such as rate of heating, and any pauses or plateaus in the heating increase or decrease. (In coffee roasting, for example, the heating ‘profile’ is very important for being able to yield particular flavor results—such as “dark roast,” or “medium roast.”) In some cases, different input raw materials (e.g., the types of beans introduced into the chamber 112) may require different heating methods to yield similar (desired) outcomes. That is, different types of green coffee beans, for example, may take different heating paths to arrive at a similar “dark-roast” end-point. This so-called heating profile is one of the typical “Product Profiles” that can be performed by the overall solar thermal processing system 10.

The system should have the ability (algorithmically) to adapt to varying Sun intensities by opening the louvers 128 either more or less, by varying chamber rate of rotation, by calling more heliostats on line to shine at the chamber, or perhaps by sending some heliostats to their stand-by condition (for less heating), and by turning fans on or off, as examples of processing variations. This ‘active response’ to varying solar conditions, as well as raw material conditions (e.g., including variations in moisture content) allow the overall system to produce consistent results without the need for close human intervention and quick (real-time) decision making.

As discussed above, the electrical power needed to operate the overall agricultural processing system 10 may be provided by a standard AC power grid connection, or may be provided by photovoltaic cells (solar panels), by charge controllers, or perhaps by batteries in some circumstances.

It should be noted that, in applications other than coffee bean roasting, the control system may remove (re-aim) the heliostat light source, but continue rotation of the hollow chamber 112 to allow for more gradual cooling of the product (e.g., other beans), before dumping the product out. Or, as an alternative, the beans may be fully retained in the hollow camber until fully cooled, perhaps using fans blowing air onto the hollow chamber's outer surface, or using fans to blow cooling air into an opening in the hollow chamber to directly cool the beans.

The thermal processing system will typically include some type of cooling area that is outside the hollow chamber, assuming the type of agricultural product will allow for that to be the case. This external cooling area is generally referred to herein by the reference numeral 118, and can take various physical forms. For example, the cooling area 118 can merely be a floor area where the agricultural product is dumped from one of the hollow chambers 112; or perhaps a stationary cooling tray could be provided (such as the cooling tray 348, discussed above); or perhaps a movable conveyor could be provided (such as a conveyor 370—see FIG. 26) which would allow the agricultural product to be automatically moved away from the heating chamber area, for cooling or other processing, if desired.

Note that, in most cases and regardless of which type of cooling area 118 is provided at a given installation, a cooling fan (such as the array of fans 354 on FIG. 25) will likely be desired (along, or proximal to, the conveyor 370, if provided), unless quick cooling of a particular type or grade of agricultural product should not be performed. However, to provide maximum flexibility, it is likely that providing one or more cooling fans would be desired for every installation, although such cooling fans may not be used for every type or grade of agricultural product. This should be left up to the design engineer of each installation.

In addition to optional cooling fans, a temperature sensor 372, such as an infrared sensor, may be provided (if desired) to detect the temperature of the agricultural product resting on the movable conveyor 370, such as a model MLX90640 infrared temperature sensor. As seen in FIG. 26, if the temperature sensor 372 is provided, it would preferably be mounted proximal to one of the sides (or edges) of that conveyor 370. And further, if the cooling area 118 for a given system is provided merely as a floor space, then the location illustrated on FIG. 26 for the temperature sensor 372 would most probably be a suitable position for mounting a similar temperature sensor to monitor the ‘dumped’ agricultural product resting on that floor space.

### Flow Chart of a Processing Cycle

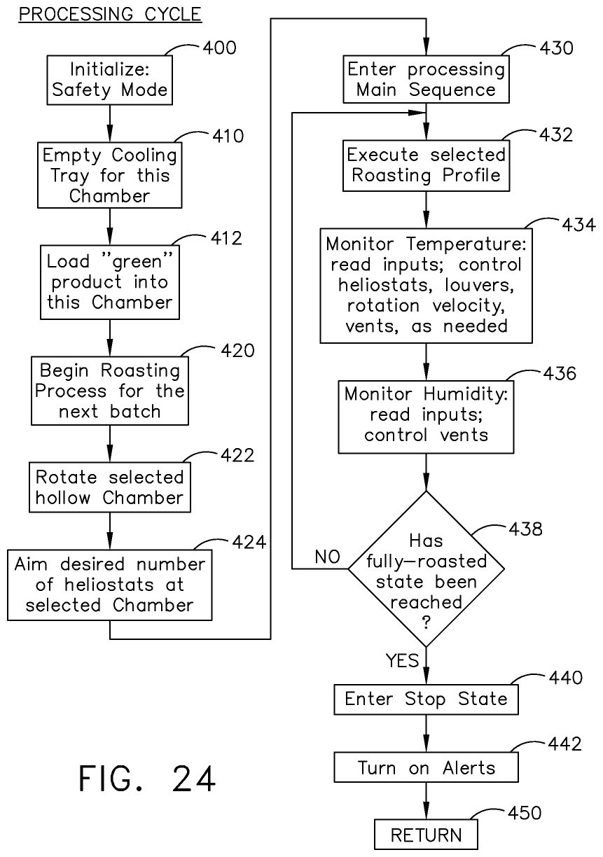

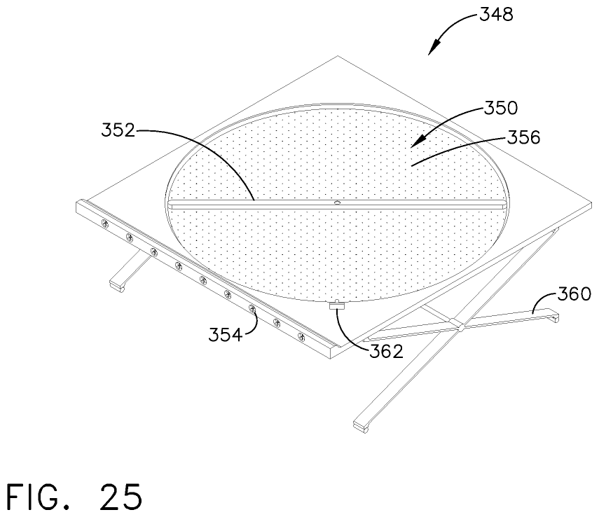

FIG. 24 is a logic flow chart showing some of the important functions that are to be performed by a solar thermal processing system, as described hereinabove. It should be noted that there are two ‘system controllers’ involved in these overall functions—i.e., the Array System Controller 30 and the Chamber System Controller 150. These two controllers work hand-in-hand; in other words, if one of the controllers performs a particular function, then the other controller may be required to perform the ‘next’ function, for the overall solar thermal processing system to operate correctly.

Furthermore, the two controllers 30 and 150 may need to cooperate in simultaneous control of similar functions; for example, the operation of the adjustable louvers 128 and the array of heliostats 20 are complementary functions. That is, both types of equipment have the ability to either increase or decrease the amount of radiant solar energy that reaches one of the hollow chambers 112, and therefore, one of those devices may be allowed to control that quantity of radiant energy while the other holds steady at its previous setting. Alternatively, both devices 128 and 20 may simultaneous be adjusted, if desired, under the command of the overall system controller, which would typically be the “human interface controller” 70—perhaps to implement an emergency shutdown of the entire system.

Starting at an initialization function at reference numeral 400, the processing system is fully stopped, and put into a ‘safety mode.’ Assuming a previous processing cycle of an agricultural product, such as coffee beans, has been completed, the cooling area 118 is emptied of finished, cooled coffee, at a function 410. In other words, the roasting chamber door has been opened and its contents removed.

The roasting container (e.g., chamber 112) is now opened if necessary, and a batch of new ‘green’ (un-roasted) coffee is loaded into the roasting container, at a function 412. When everything is ready to begin the processing of the next batch of agricultural products, the overall control system is triggered to begin the roasting process, at a function 420. (This will involve both of the above-noted ‘system controllers’ 30 and 150.) As a result, the selected roasting container (chamber 112) begins to rotate, using its servo motor drive at a function 422, and the array of heliostats 20 are aimed so as to focus sunlight (the reflected radiant energy 14) on the selected roasting container at a function 424, thereby heating that selected hollow chamber 112.

The processing cycle has now entered into its main sequence of the roasting process at a function 430, which is monitored by the Chamber System Controller 150 to produce optimal product quality. During the processing cycle at this function 430, the Chamber System Controller will monitor input data received from various sources, including output signals from the optional sensors, such as the inside air temperature of the roasting container (via the temperature sensor 224, e.g., a thermocouple), the inside air humidity (via the sensor 222), and perhaps the external surface temperature of the roasting container, via a temperature sensor 230 such as a thermocouple—see FIG. 9.

Additionally, the overall solar intensity can be monitored, if desired, via one or more photoelectric sensors 54, located either at the array of heliostats, or perhaps located at the enclosure's roof 108 (as a photosensor 109). Note that these photosensors 54 and/or 109 will be exposed to the full solar radiation, to act as a solar intensity monitor. (Also note: if a sensor 109 is used, it preferably would be mounted proximal to the array of solar panels 108, and thus preferably would have a physically small footprint, such as that provided by a weatherproof photodiode.)

The sensors being monitored by the Chamber System Controller 150 will have their signals sampled as quickly, or a slowly, as deemed necessary by the designer of the overall system. Physical parameters such as temperature and humidity typically are relatively slow-moving for a given physical structure, and therefore, they probably do not need to be sampled as often as some other types of physical parameters, such as pressure or flow rates. However, in general for this solar thermal processing system 10, at least the temperature should be monitored (sampled) every few seconds, at the slowest. This will allow the overall control system to ‘add’ or ‘subtract’ heat, as needed (see below) without significant temperature overshoots or undershoots of the interior space of the hollow chamber 112, and its contained agricultural product presently undergoing processing. Modern Analog-to-Digital Converters (A/D Converters) can easily sample much more quickly than once every few seconds. (But note: some agricultural products may not require ‘close control’ of the roasting temperature, so the above statement could be ignored in such circumstance.)

The Chamber System Controller 150 will also have the ability to execute a pre-determined roasting ‘profile’ using at least one optimal roasting ‘profile’ that is stored in the system memory circuit 154, to be executed by the processing circuit 152 during a function 432. Such pre-determined roasting ‘profiles’ can include, for example, time-vs-temperature curves. In one example, the desired inside air temp after five (5) minutes from the start is 100 degrees F., and then at seven (7) minutes from the start is 200 degrees F., and at 9 minutes from start is 400 degrees F. The way that coffee beans, for example, are heated has a causal effect on flavor of the finished coffee, which involves such parameters as the rate of heating, and the length of time held at a given temperature.

The overall control system ‘drives’ the process to closely approximate one of the stored ideal roasting profiles (i.e., ‘Product Profiles’), in a closed-loop feedback process. The overall control system is specifically designed to manage both the temperature and the humidity of the air inside the hollow chamber 112 during the main sequence 430, including (during) the pre-determined ‘roasting profile’ of function 432.

The internal temperature, at a function 434, can be influenced by: (a) directing more heliostats onto the roasting container (chamber 112) to increase its internal temperature, or directing some or all of the heliostats away from the chamber 112 to reduce its internal temperature; (b) opening or closing a louvered aperture (e.g., the louvers 128), which controls the quantity (percentage) of light (i.e., the radiant energy 14) reflected from the heliostats 22 to the target (i.e., the selected hollow chamber 112); (c) varying the rotational motion of the coffee-containing container in the solar radiant heat-beam (i.e., the selected hollow chamber 112); and/or (d) opening or closing vents 234 in the roasting container (hollow chamber 112) to allow hot air to escape and thereby reduce its internal temperature.

It should be noted that the use of adjusting the louvers 128 in part (b), above, has a similar effect to pointing either more or less heliostats (in part (a), above) at the roasting chamber. In some cases, adjusting the louvers may be faster-acting than adjusting the aiming of some of the heliostats.

It should be noted that varying the rotational velocity (in part (c), above) has the following effects: a slow rotation creates a very hot front container surface, and coffee beans that come in contact with this surface are heated intensely, while other beans touching the back (unlighted) surface of the container typically are roasted little. This usually is an undesirable result. On the other hand, a fast rotation will typically create more air movement, and should cause the roasting temperature to be more averaged, throughout the chamber 112.

The general case for processing an agricultural product using the solar thermal processing system 10 is to implement a Product Profile as a time vs. temperature profile at function 434, in which, under the control of the system controller, a predetermined number of the individual heliostat-aiming actuators 24 is caused to aim a corresponding number of heliostats 22 at a specific one of the rotatable hollow chambers 112 during a thermal processing cycle—e.g., the hollow chamber on the right side, as seen in FIG. 1. Then, during this processing procedure, and still under the control of the system controller, an internal space temperature may be monitored using at least one of the internal sensors—e.g., the temperature sensor 224 (or 324). As the processing procedure continues, if the actual internal space temperature varies from an ideal temperature vs. time profile by an amount greater than a predetermined tolerance (such as +2 or −2 degrees F.), then (and still under the control of the system controller) aiming either additional or fewer of the heliostats 22 at the specific one of the rotatable hollow chambers 112, depending on whether the actual internal space temperature is currently too high or too low.

Another way of describing the time vs. temperature profile at function 434 is, as follows: under control of the system controller, (a) a time variable begins timing at the commencement of adjusting at least one of the aiming actuators 24 for at least one heliostat 22 (to be aimed at a specific one of the rotatable hollow chambers 112—see below) and, for that same specific rotatable hollow chamber, at least one of the louver actuators 122 is adjusted so as to at least partially open its corresponding louver subassembly 128; (b) the interior temperature is periodically monitored (sampled) in time intervals, using that specific hollow chamber's temperature sensor 224 (or 324); and (c) the individual heliostat(s) 22 are aimed by their respective aiming actuator(s) 24 to direct reflected solar radiant energy at the same rotatable hollow chamber, to raise its interior temperature.

At the commencement of function 434, the system is always aiming at least one of the heliostats 22 at the specific rotatable hollow chamber 112 that contains the agricultural product to be processed, because the initial goal is always to raise that chamber's interior temperature. Of course, if too many heliostats are being aimed at that chamber, or perhaps if the sunlight suddenly becomes much stronger (e.g., a cloud passes by), then the periodic temperature monitoring will notice a faster temperature rise than desired (e.g., using the temperature tolerance described above for the “general case”), and the number of heliostats will quickly be decreased, and/or the louvers will be quickly (fully or partially) closed (at least temporarily). The ultimate goal (of course) is to closely match the product profile for that specific agricultural product being processed.

It will be understood that, in this above “general case” description, the term “system controller” refers to the combination of the Array System Controller 30 and the Chamber System Controller 150. As discussed herein, these two individual controllers 30 and 150 must be programmed to work together (i.e., by communicating commands and other information) in order to effectively implement this processing scheme; or these two controllers could perhaps be literally combined into a single processing circuit with appropriate multi-tasking software.

If monitored, the internal humidity, at a function 436, can be influenced by opening or closing vents 234 in the roasting container (i.e., the selected hollow chamber 112) to allow damp air to escape and reduce internal temperature.

When a roasting process has finished, as determined at a decision function 438, the agricultural product (e.g., coffee beans) should now have reached a fully-roasted state. The Chamber System Controller 150 makes this determination based on information both from the predetermined ‘Roasting Profile,’ and from live data from the system's various sensors. If the fully-roasted state has not yet been reached, then the logic flow is directed back to the function 432, and the selected ‘Roasting Profile’ continues to be executed.

If the fully-roasted state has been reached at function 438, then a “Stop State” function 440 is entered. At this function 440, the Chamber System Controller may: (z) stop rotation of the hollow container 112; (y) move the aiming points of the heliostats 20 either to a safe position (also sometimes referred to herein as a “safe mode”), or to a second roasting container (e.g., the other hollow chamber 112 of the overall roasting system 100); (x) physically orient the hollow chamber 112 optimally so as to open the hatch (e.g., the door 206) to allow finished hot beans to pour out of the hollow chamber onto, e.g., the cooling tray 348; (w) trigger the cooling tray 348 to begin stirring the beans while blowing air through them; and (v) at a function 442, play an audio alert 180 and/or visible light alert 182 to inform the system operators that this batch of beans is ready to be taken away, and that new ‘green’ beans can now be loaded into this hollow chamber 112, for future processing.

It should be noted that, during parts (w) and (v), above, the Chamber System Controller 150 may use another temperature sensor 362 (such as a thermal IR sensor) mounted in the cooling tray, to determine when the roasted beans have become sufficiently cooled for unloading.

It should be noted that, during part (w), above, the Chamber System Controller 150 will also use the temperature sensor to determine when the stirring paddle 352 and fan(s) 354 can be turned off, once the roasted beans have cooled.

The logic flow for this particular processing cycle has reached the end of its roasting and cooling functions, and the logic flow will now be directed to a “Return” function 450, at which time the processing circuit 152 will return to performing other functions, as needed. The heliostat array 20 will be directed either to a ‘safe’ position, or will be directed at the other roasting chamber so as to process the next batch of agricultural products.

It will be understood that a roasting cycle for “Chamber #1” could be occurring simultaneously when a cooling cycle for 37 Chamber #2 is occurring, if the software computer program that is stored in the memory circuit 154 is programmed to act in a multi-tasking manner. This simultaneous cycling (using multi-tasking software) of the agricultural products is likely to be the preferred way of processing these types of agricultural products with the system 10.

With regard to the flow chart of FIG. 24, it can be seen from the above description that the temperature and humidity sensors play a major role in the decision function at 438, and in adjusting any of the roasting system's actuators during the Roasting Profile cycle starting at function 432. Such a sophisticated system would likely be needed to properly roast certain types of ‘high-level’ products, such as coffee beans, in which the actual temperatures and humidity truly need to be closely controlled. However, as discussed above, a simplified roasting system could instead be provided, in which the elapsed time of the Main Sequence for the Roasting Profile becomes the primary control attribute. In such a simplified roasting system, the functions 434 and 436 would be replaced by a function of monitoring the elapsed time since beginning execution at the function 432.

With regard to such a simplified roasting system, the number of heliostats 22 being aimed at the roasting chamber of interest 112 would still be an important parameter, and these heliostats could be controlled either automatically or manually, as noted above. If the heliostats 22 are to be controlled automatically, then a photosensor 54 or 109 could be installed (as described above), and the number of heliostats that are desired for the roasting cycle could be controlled based on the quantity of solar incident energy that is impacting the heliostat array 20. In that circumstance, then the function 434 would become one of monitoring the amount of solar incident energy (in real time), and the function 436 would become one of automatically adjusting the number of heliostats 22 being aimed at the roasting chamber 112. (Note that, if the roasting chamber subassembly 100 has, for whatever reason, been positioned at a location that is not directly receiving sunlight, then the system should use a photosensor at the heliostat array 20 (i.e., the photosensor 54) to monitor the quantity of solar incident energy that is being received, in real time.

Referring now to FIG. 26, the entire system 10 is depicted in a view that is almost identical to that of FIG. 1, in which the heliostat array 20 is aimed at the roasting chamber on the left of this view, rather than the chamber on the right (as in FIG. 1). Furthermore, the chamber on the right of this view has been rotated horizontally 90 degrees (i.e., about a vertical axis) as compared to its orientation depicted in FIG. 1. In this orientation of FIG. 26, the right chamber 112 can be tilted either forward or backward (with respect to the vertical) so as to either unload, or load an agricultural product.

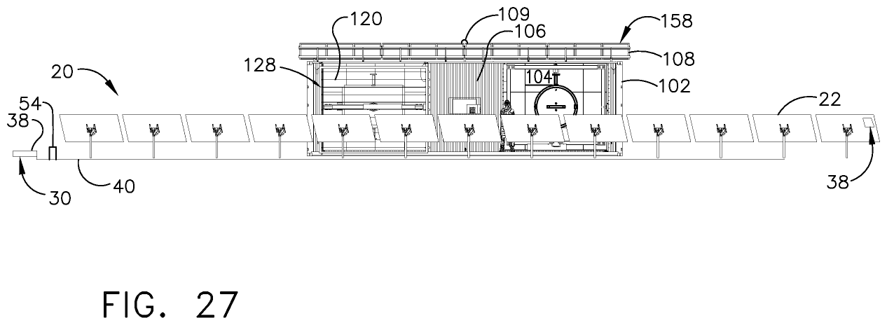

Referring now to FIG. 27, the roasting chamber on the left in this view is now receiving the solar radiant energy from the heliostat array 20, through the opened louvers at 128. The roasting chamber on the right in this view is ready to be tilted (in the vertical—i.e., about a horizontal axis) for either loading or unloading an agricultural product, and thus, is not receiving solar radiant energy from the heliostat array 20 in this view.

Note that some of the embodiments illustrated herein do not have all of their components included on some of the figures herein, for purposes of clarity. To see examples of such heliostat heating systems for other uses, especially for earlier designs, the reader is directed to other U.S. patents and applications owned by the inventor Karl von Kries, or his company, LightManufacturing, Inc. This includes the following U.S. patents and U.S. published patent applications: U.S. Pat. Nos. 8,662,877, 9,034,238, 9,575,222, and 11,009,263; also published U.S. patent application No. 2014/0230807, and published U.S. patent application, No. 2021/0269625. These documents are incorporated by reference herein, in their entirety.

It will be understood that the logical operations described in relation to the flow chart of FIG. 24 can be implemented using sequential logic (such as by using microprocessor technology), or using a logic state machine, or perhaps by discrete logic; it even could be implemented using parallel processors. One preferred embodiment may use a microprocessor or microcontroller (e.g., microcontroller 32 or 152) to execute software instructions that are stored in memory cells within an ASIC. In fact, the entire microcontroller, along with RAM and executable ROM, may be contained within a single ASIC, in one mode of the technology disclosed herein. Of course, other types of circuitry could be used to implement these logical operations depicted in the drawings without departing from the principles of the technology disclosed herein. In any event, some type of processing circuit will be provided, whether it is based on a microprocessor, a microcomputer, a microcontroller, a logic state machine, by using discrete logic elements to accomplish these tasks, or perhaps by a type of computation device not yet invented; moreover, some type of memory circuit will be provided, whether it is based on typical RAM chips, EEROM chips (including Flash memory), by using discrete logic elements to store data and other operating information (such as the Roasting Profile data stored, for example, in memory circuit 154), or perhaps by a type of memory device not yet invented. In general, the memory circuit of a particular electronic product will contain instructions that are executable by the processing circuit of that same particular electronic product.

It will also be understood that the various functions being performed by a first system controller (such as the Array System Controller 30) and by a second system controller (such as the Chamber System Controller 150) could be integrated into a single overall system controller that uses a single processing circuit, if desired by the system designer. While it makes sense to divide the control functions of controlling the heliostat array from the control functions of controlling the set of hollow chambers, this is not at all a primary requirement. With today's advanced microprocessors and microcontrollers, all of these control functions could be programmed to be operated by a single such microprocessor or microcontroller chip. And along the same lines, the actual computer programs to be used by two individual system controllers (e.g., microcontroller chips) could, instead, be designed to be executed on a single microcontroller chip, preferably using multi-tasking programming techniques, which are well-known in the current state of the art. Furthermore, the “human interface” computer 70 could also be integrated with the above two system controllers, if desired, so that all functions would be controlled by a single processing circuit—in this case, perhaps an on-site laptop computer or sophisticated tablet computer. On the other hand, the greater the extent of system integration, then perhaps the less flexibility of the overall control system. These are system engineering questions, best answered by the inventor(s).

It will be further understood that any type of product described herein that has moving parts, or that performs functions (such as computers with processing circuits and memory circuits), should be considered a “machine,” and not merely as some inanimate apparatus. Such “machine” devices should automatically include power tools, printers, electronic locks, rotating heating chamber and the like, as those example devices each have certain moving parts. Moreover, a computerized device that performs useful functions should also be considered a machine, and such terminology is often used to describe many such devices; for example, a solid-state telephone answering machine may have no moving parts, yet it is commonly called a “machine” because it performs well-known useful functions.

Additionally, it will be understood that a computing product that includes a display to show information to a human user, and that also includes a “user operated input circuit” so the human user is able to enter commands or data, can be provided with a single device that is known as a “touchscreen display.” In other words, if a patent claim recites a “display” and a “user operated input circuit” as two separate elements, then a single touchscreen display, in actually, is exactly the same thing. It should be noted that a touchscreen display usually includes a virtual keypad, and therefore, a “user operated input circuit” typically comprises a virtual keypad, particularly on smart phones and on tablet computers. Moreover, in this situation, the word “virtual” means that it is not a hardware keypad; more specifically, “virtual” means that it is formed (i.e., “created”) on the display screen because of software being executed by a processing circuit.

As used herein, the term “proximal” can have a meaning of closely positioning one physical object with a second physical object, such that the two objects are perhaps adjacent to one another, although it is not necessarily required that there be no third object positioned therebetween. In the technology disclosed herein, there may be instances in which a “male locating structure” is to be positioned “proximal” to a “female locating structure.” In general, this could mean that the two (male and female) structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two (male and female) structures actually touch one another along a continuous surface. Or, two structures of any size and shape (whether male, female, or otherwise in shape) may be located somewhat near one another, regardless if they physically abut one another or not; such a relationship could still be termed “proximal.” Or, two or more possible locations for a particular point can be specified in relation to a precise attribute of a physical object, such as being “near” or “at” the end of a stick; all of those possible near/at locations could be deemed “proximal” to the end of that stick. Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

As used herein, the term “real time” (or “in real time”) refers to an amount of time that the control system described herein is able to realistically react to a change in a control input parameter (such as measuring the quantity of an attribute, e.g., received solar energy, or the value perceived by a temperature or humidity sensor). “Real time” does not mean “immediately,” because there is always some measurable delay in making a response to such a change of any control input parameter. The shortest possible delay is typically the communication time to ‘send’ the updated value from that specific sensor to the system controller PLUS the processing time for the system controller to reach the processing instruction that actually inspects that input variable (i.e., to ‘read’ that sensor's value), and also PLUS the processing time needed before the system controller has a chance to send a command to an appropriate actuator(s), if it has been determined that such a ‘change of state’ command is needed.

If a particular control input is truly critical, then the system may be programmed to generate a non-maskable interrupt upon some type of ‘flag’ being generated due to some type of external change in an input sensor, or data line. If that type of “interruptable” input flag is used, then that would likely produce the fastest possible “real time” response in a computerized process control system, especially if the input (or data line) is a digital input, rather than an analog input. Generally speaking, the system described herein probably would have no need for really fast response times (e.g., times measured in microseconds), unless an emergency shutoff function is deemed necessary by the overall system's design engineer. And even in that circumstance, some additional electrical circuitry would likely be required—the heliostats are the main source of energy in this system, and they can be commanded to re-aim to a ‘safe mode’ position, if necessary; and that mode of operation could be arranged through additional wiring and user-controlled switches, if this is deemed necessary.

As used herein, the terms “to monitor” or “monitoring” refer to use of an input circuit to determine the value of a sensor, or the value of elapsed time, for example. The act of “monitoring” a sensor (or a sensor's output value) is typically performed by measuring the voltage or electrical current that is being produced by that sensor, either in real time, or in predetermined sampling time intervals. In most (or all) cases herein, the sensor is an analog device which will either output an analog value (e.g., a current or a voltage signal), or if that sensor is provided with its own A/D Converter (analog-to-digital), then the sensor may have the ability to output a digital value—either on multiple (parallel) wires, or as a serial data signal on one pair of wires. In any case, the act of “monitoring” a value often refers to tracking a given sensor's output signal value over time, either continuously or at predetermined time intervals, or (in many cases) only at moments ‘as needed’ by the software that is being executed by one of the system's computer/processing circuits. In other words, the act of “monitoring” often does not need to be performed at precise time intervals, unless the system design engineer decides that—for a given sensor's output value—precise time tracking (i.e., monitoring) is truly necessary. Finally: tracking/monitoring a given sensor in many data acquisition and control systems sometimes includes storing the sensor's data values in the memory circuit of the system controller, sometime over fairly long time intervals (or production runs); this again is to be determined by the overall system design engineer.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

What is claimed is:

1. A solar thermal processing system, comprising:
(a) at least one heliostat, and at least one aiming actuator that controls the at least one heliostat;
(b) at least one rotatable hollow chamber, having a door that opens for loading and unloading an agricultural product to and from an interior space of the at least one rotatable hollow chamber;
(c) at least one sensor for detecting a predetermined physical parameter that is related to at least one of: (i) the at least one heliostat and (ii) the at least one rotatable hollow chamber;
(d) at least one motor that, if actuated, rotates the at least one rotatable hollow chamber;
(e) a cooling area for temporarily holding the agricultural product for cooling, after the agricultural product has been removed from the interior space of the at least one rotatable hollow chamber;
(f) a system controller that includes:
(i) at least one processing circuit;
(ii) at least one memory circuit including instructions executable by the processing circuit; and
(iii) at least one input/output interface circuit that is in communication with the at least one sensor and with the at least one processing circuit; and
(g) an electrical power source;
wherein:
(h) the at least one processing circuit is operable to control a thermal processing cycle so as to:
(i) control the at least one aiming actuator to cause the at least one heliostat to aim reflected solar radiant energy at the at least one rotatable hollow chamber that contains the agricultural product;
(ii) control the at least one motor to rotate the at least one rotatable hollow chamber;
(iii) monitor the predetermined physical parameter, using the at least one sensor;
(iv) follow a predetermined product profile to adjust the at least one aiming actuator, to control the amount of reflected solar radiant energy that strikes the surface of the at least one rotatable hollow chamber containing the agricultural product;
(v) complete the predetermined product profile, and then:
(vi) empty the agricultural product from the interior space of the at least one rotatable hollow chamber, and place the agricultural product on the cooling area.

2. The solar thermal processing system of claim 1, wherein: the at least one sensor detects a physical parameter of the interior space of the at least one rotatable hollow chamber.

3. The solar thermal processing system of claim 1, wherein: the cooling area comprises one of a floor area, a stationary tray, and a movable conveyor.

4. The solar thermal processing system of claim 1, further comprising:
at least one louver actuator that, if actuated, adjusts at least one louver subassembly that controls an amount of visible electromagnetic energy that is permitted to strike a surface of the at least one rotatable hollow chamber.

5. The solar thermal processing system of claim 4, wherein: to follow a predetermined product profile, the at least one processing circuit adjusts at least one of:
(a) the at least one aiming actuator, and
(b) the at least one louver actuator,
to control the amount of reflected solar radiant energy that strikes the surface of the at least one rotatable hollow chamber containing the agricultural product.

6. The solar thermal processing system of claim 1, wherein:
the at least one rotatable hollow chamber comprises two individual hollow chambers, each including: the door, the interior space, the at least one sensor, and the at least one motor that rotates the individual hollow chamber about at least one axis of rotation.

7. The solar thermal processing system of claim 6, further comprising:
an enclosure that at least partially covers the two individual hollow chambers; and
at least one louver subassembly that is mounted on a front portion of the enclosure, so as to be positioned between the at least one heliostat and the two individual hollow chambers, so as to control the amount of reflected solar radiant energy that is directed from the at least one heliostat;
wherein:
the at least one louver subassembly comprises two individual louver subassemblies, each associated with one of the at least one louver actuator, in which a first one of the two individual louver actuators is controlled by the system controller so as to allow at least a portion of the reflected solar radiant energy to strike a first one of the individual hollow chambers, and a second one of the two individual louver actuators is controlled by the system controller so as to block substantially all of the reflected solar radiant energy that may be directed at the second one of the individual hollow chambers.

8. The solar thermal processing system of claim 6, wherein:
the at least one sensor comprises a temperature sensor and a humidity sensor;
wherein:
the temperature sensor is installed so as to detect a temperature within the interior space of the at least one rotatable hollow chamber; and
the humidity sensor is installed so as to detect a humidity within the interior space of the at least one rotatable hollow chamber.

9. The solar thermal processing system of claim 8, wherein:
the predetermined product profile comprises a time vs. temperature profile of the interior space of the at least one rotatable hollow chamber, in which:
(a) under control of the system controller, a time variable begins timing at the commencement of adjusting the at least one aiming actuator of the at least one heliostat at a specific one of the at least one rotatable hollow chamber, and, for the same specific one of the at least one rotatable hollow chamber, the at least one louver actuator is adjusted so as to at least partially open the corresponding at least one louver subassembly;
(b) under control of the system controller, a temperature is periodically monitored in time intervals, using the at least one temperature sensor for the specific one of the at least one rotatable hollow chamber; and
(c) under control of the system controller, the at least one heliostat is aimed by the at least one aiming actuator to direct reflected solar radiant energy at the same specific one of the at least one rotatable hollow chamber, to raise the interior temperature of the same specific one of the at least one rotatable hollow chamber.

10. The solar thermal processing system of claim 1, wherein:
the at least one heliostat comprises an array of individual heliostats, each having an individual one of the at least one aiming actuator that controls the at least one heliostat; and
a corresponding one of the at least one aiming actuator is under the control of the system controller so as to:
(a) cause the corresponding one of the at least one heliostat to be aimed at one of the at least one rotatable hollow chamber; or
(b) cause the corresponding one of the at least one heliostat to be aimed in a “safe mode” direction.

11. The solar thermal processing system of claim 10, wherein:
under the control of the system controller, a predetermined number of the at least one aiming actuator is caused to aim the corresponding one of the at least one heliostat to be aimed at a specific one of the at least one rotatable hollow chamber during a thermal processing cycle;
under the control of the system controller, a temperature of the interior space is periodically monitored using the at least one sensor; and
if the interior space temperature varies from an ideal temperature vs. time profile by an amount greater than a predetermined tolerance, then causing either additional or fewer of the at least one heliostat to aim at the specific one of the at least one rotatable hollow chamber, depending on whether the interior space temperature is currently too low or too high, respectively.

12. The solar thermal processing system of claim 7, wherein: the at least one louver actuator comprises at least one of:
(a) an individual louver actuator for each individual blade of the at least one louver subassembly; and
(b) a single louver actuator that operates a linkage that is connected to a plurality of louver blades of the at least one louver subassembly.

13. The solar thermal processing system of claim 1, wherein the electrical power source comprises at least one of:
(a) at least one solar panel that converts sunlight into electrical energy;
(b) at least one battery; and
(c) an alternating current power source.

14. The solar thermal processing system of claim 1, further comprising a human interface computer that includes:
a second processing circuit;
a second memory circuit including instructions executable by the second processing circuit;
a display;
at least one of a keyboard and a keypad; and
a radio communications circuit;
wherein: the second radio communications circuit allows the human interface computer to be in communication with a first radio communications circuit that is included with the system controller.

15. A solar thermal processing system, comprising:
(a) at least one heliostat, and at least one aiming actuator that controls the at least one heliostat;
(b) at least one rotatable hollow chamber, having a door that opens for loading and unloading an agricultural product to and from an interior space of the at least one rotatable hollow chamber;
(c) at least one sensor for detecting a predetermined physical parameter that is related to at least one of: (i) the at least one heliostat and (ii) the at least one rotatable hollow chamber;
(d) at least one motor that, if actuated, rotates the at least one rotatable hollow chamber;
(e) at least one louver actuator that, if actuated, adjusts at least one louver subassembly that controls an amount of visible electromagnetic energy that is permitted to strike a surface of the at least one rotatable hollow chamber;
(f) a cooling area for temporarily holding the agricultural product for cooling, after the agricultural product has been removed from the interior space of the at least one rotatable hollow chamber;
(g) a system controller that includes:
(i) at least one processing circuit;
(ii) at least one memory circuit including instructions executable by the processing circuit; and
(iii) at least one input/output interface circuit that is in communication with the at least one sensor and with the at least one processing circuit; and
(h) an electrical power source;
wherein:
(i) the at least one processing circuit is operable to control a thermal processing cycle so as to:
(i) control the at least one aiming actuator to cause the at least one heliostat to aim reflected solar radiant energy at the at least one rotatable hollow chamber that contains the agricultural product;
(ii) control the at least one motor to rotate the at least one rotatable hollow chamber;
(iii) monitor the predetermined physical parameter, using the at least one sensor;
(iv) follow a predetermined product profile to adjust at least one of:
(A) the at least one aiming actuator, and
(B) the at least one louver actuator;
wherein:
(C) a first one of the at least one aiming actuator and the at least one louver actuator may be allowed to remain at its present setting, while a second one of the at least one aiming actuator and the at least one louver actuator is controlled in real time so as to alter its setting to control the amount of reflected solar radiant energy that strikes the surface of the at least one rotatable hollow chamber containing the agricultural product; or
(D) both the first one and the second one of the at least one aiming actuator and the at least one louver actuator may be controlled simultaneously in real time so as to alter both of their settings to control the amount of reflected solar radiant energy that strikes the surface of the at least one rotatable hollow chamber containing the agricultural product;
(v) complete the predetermined product profile, and then:
(vi) empty the agricultural product from the interior space of the at least one rotatable hollow chamber, and place the agricultural product on the cooling area.

16. The solar thermal processing system of claim 15, wherein: the at least one sensor detects a physical parameter of the interior space of the at least one rotatable hollow chamber.

17. A solar thermal processing system, comprising:
(a) at least one heliostat, and at least one aiming actuator that controls the at least one heliostat;
(b) at least one rotatable hollow chamber, having a door that opens for loading and unloading an agricultural product to and from an interior space of the at least one rotatable hollow chamber;
(c) at least one motor that, if actuated, rotates the at least one rotatable hollow chamber;
(d) a cooling area for temporarily holding the agricultural product for cooling, after the agricultural product has been removed from the interior space of the at least one rotatable hollow chamber;
(e) a system controller that includes:
(i) at least one processing circuit;
(ii) at least one memory circuit including instructions executable by the processing circuit; and
(iii) at least one input/output interface circuit that is in communication with the at least one processing circuit; and
(f) an electrical power source;
wherein:
(g) the at least one processing circuit is operable to control a thermal processing cycle so as to:
(i) control the at least one motor to rotate the at least one rotatable hollow chamber;
(ii) follow a predetermined product profile to monitor elapsed time for the thermal processing cycle;
(iii) control, either manually or automatically, the at least one aiming actuator to cause the at least one heliostat to aim reflected solar radiant energy at the at least one rotatable hollow chamber that contains the agricultural product;
(iv) complete the predetermined product profile, as determined once the elapsed time reaches a predetermined time value, and then:
(v) empty the agricultural product from the interior space of the at least one rotatable hollow chamber, and place the agricultural product on the cooling area.

18. The solar thermal processing system of claim 17, wherein: if the at least one aiming actuator is to be controlled automatically, then further comprising:
a photosensor that is mounted so as to receive direct sunlight during the thermal processing cycle, so as to monitor the solar incident energy being received proximal to the at least one heliostat.

19. The solar thermal processing system of claim 17, wherein: if the at least one aiming actuator is to be controlled manually, then further comprising:
a human interface computer that includes:
a second processing circuit;
a second memory circuit including instructions executable by the second processing circuit;
a display;
at least one of a keyboard and a keypad; and
a second radio communications circuit;
wherein: the second radio communications circuit allows the human interface computer to be in communication with a first radio communications circuit that is included with the system controller.

20. A method for controlling a solar thermal processing system, comprising:
(a) providing:
(i) at least one heliostat, and at least one aiming actuator that controls the at least one heliostat;
(ii) at least one rotatable hollow chamber, having a door that opens for loading and unloading an agricultural product to and from an interior space of the at least one rotatable hollow chamber;
(iii) at least one sensor for detecting a predetermined physical parameter that is related to at least one of: (i) the at least one heliostat and (ii) the at least one rotatable hollow chamber;
(iv) at least one motor that, if actuated, rotates the at least one rotatable hollow chamber;
(v) a cooling area for temporarily holding the agricultural product for cooling, after the agricultural product has been removed from the interior space of the at least one rotatable hollow chamber;
(vi) a system controller that includes: (A) at least one processing circuit; (B) at least one memory circuit including instructions executable by the processing circuit; and (C) at least one input/output interface circuit that is in communication with the at least one sensor and with the at least one processing circuit; and
(vii) an electrical power source; and
(b) controlling a thermal processing cycle, by:
(i) controlling the at least one aiming actuator to cause the at least one heliostat to aim reflected solar radiant energy at the at least one rotatable hollow chamber that contains the agricultural product;
(ii) controlling the at least one motor to rotate the at least one rotatable hollow chamber;
(iii) monitoring the predetermined physical parameter, using the at least one sensor;
(iv) following a predetermined product profile by adjusting the at least one aiming actuator, thereby controlling the amount of reflected solar radiant energy that strikes the surface of the at least one rotatable hollow chamber containing the agricultural product;
(v) completing the predetermined product profile, and then:
(vi) emptying the agricultural product from the interior space of the at least one rotatable hollow chamber, and place the agricultural product on the cooling area.

21. A method for controlling a solar thermal processing system, comprising:
(a) providing:
(i) at least one heliostat, and at least one aiming actuator that controls the at least one heliostat;
(ii) at least one rotatable hollow chamber, having a door that opens for loading and unloading an agricultural product to and from an interior space of the at least one rotatable hollow chamber;
(iii) at least one motor that, if actuated, rotates the at least one rotatable hollow chamber;
(iv) a cooling area for temporarily holding the agricultural product for cooling, after the agricultural product has been removed from the interior space of the at least one rotatable hollow chamber;
(v) a system controller that includes: (A) at least one processing circuit; (B) at least one memory circuit including instructions executable by the processing circuit; and (C) at least one input/output interface circuit that is in communication with the at least one processing circuit; and
(vi) an electrical power source; and
(b) controlling a thermal processing cycle, by:
(i) controlling the at least one motor to rotate the at least one rotatable hollow chamber;
(ii) following a predetermined product profile to monitor elapsed time for the thermal processing cycle;
(iii) controlling, either manually or automatically, the at least one aiming actuator to cause the at least one heliostat to aim reflected solar radiant energy at the at least one rotatable hollow chamber that contains the agricultural product;
(iv) completing the predetermined product profile, as determined once the elapsed time reaches a predetermined time value, and then:
(v) emptying the agricultural product from the interior space of the at least one rotatable hollow chamber, and place the agricultural product on the cooling area.
